(19) United States
(12) Patent Application Publication
(10) Pub. No.: US 2005/0046554 A1
(43) Pub. Date: Mar. 3, 2005

(54) System and device for locking an automobile steering axis

(76) Inventor: Achawan Atthaprasith, Bangkok (TH)

Correspondence Address: BIRCH STEWART KOLASCH & BIRCH, PO BOX 747, FALLS CHURCH, VA, 22040-0747, US

(21) Appl. No.: 10/921,130

(22) Filed: Aug. 19, 2004

(30) Foreign Application Priority Data
Aug. 22, 2003 (TH) 084691

(51) Int. Cl. B60R 25/10

(52) U.S. Cl. 340/426.1

(57) ABSTRACT

A system and device for locking an automobile steering axis according to the present invention is an automobile stealing prevention device permanently installed in an automobile provided with of an electrical-electronic system to control the lock and unlock mechanism of the automobile steering axis to facilitate locking operation. When the locking device according to the invention is in locked state the steering wheel of the automobile is unable to turn as usual. Moreover, the efficiency in preventing stealing is enhanced by providing a control unit to control the start system and the mobility system of the automobile including an anti-theft alarm system so as to deactivate the start system and the mobility system of the automobile so that they cannot be operated in the locked state according to the invention. If an abnormal incident occurs, the anti-theft alarm system will send signals to the owner or authorized persons.

### FIELD OF THE INVENTION

Electrical-electronic engineering and other fields related to a mechanism for preventing automobile stealing

### BACKGROUND OF INVENTION

A device for locking an automobile steering axis is a device permanently installed in an automobile for preventing stealing. When such a device is locked, the steering wheel to which it is attached is unable to turn. Since such a steering wheel is connected to a steering shaft, its being locked makes the steering shaft unable to turn and thus the direction of movement of the automobile cannot be controlled. Steering axis locking devices in current use, however, are highly complicated. Namely, every time a user desires to lock such a device so that a steering wheel to which it is attached is unable to turn, it is necessary that the user operate the device with his/her both hands, with one hand pulling a part provided to be pulled for locking and the other hand turning the steering wheel so that a metal jacket of the steering axis locking device moves to cover a corresponding collet attached to the steering axis to be fittingly locked. Therefore, both hands are required for the locking operation aforementioned, otherwise a steering axis cannot be locked. Each locking operation is thus highly complicated. Moreover, when a user desires to unlock such a device, it is necessary that he/she apply a key to a lock thereof. The unlocking method aforementioned is highly inconvenient since the position where an automobile steering axis locking device is installed is of limited space and positioned below a front panel. Therefore, it is required that a user bend down to apply a key to the device in order to unlock it in a narrow space. Apparently, this makes it inconvenient and complicated to lock and unlock a steering axis locking device of the type aforementioned.

### SUMMARY OF INVENTION

The present invention is related to an automobile steering axis locking device for preventing automobile stealing which disable turning of the steering shaft, wherein the system and device for locking an automobile steering axis according to the present invention are a combination of an electrical-electronic system and a mechanical system having a motor as a power source thereof for rotating the mechanical system to lock a steering axis connected to a steering shaft so that the steering shaft unable to turn as usual and to unlock the steering axis with no key required so that the steering shaft can be turned as usual. The cooperation between the systems facilitates the use of the device. Moreover, efficiency in preventing stealing is enhanced by providing a start system controlling unit and a mobility system including an anti-theft alarm system for deactivating the operation of the start system and the mobility system so they cannot function as usual and for activating the anti-theft alarm system when the locking device according to the invention is in a locked state. Such anti-theft alarm system comprises at least a siren for emitting sounds to call attention of people nearby and to alert the owner of the automobile.

The first objective of the present invention is to prevent stealing of automobiles including other vehicles having a steering axis by providing a electrical-electronic system for controlling a mechanical system to lock or unlock an automobile steering axis with a motor as a power source thereof to drive the mechanical system to execute such locking and unlocking to facilitate the use of the device.

The next objective is for enhancing capability and efficiency in preventing stealing. Accordingly, there are provided an encoder device/circuit for encoding signals and a decoder circuit for checking whether an encoded signal received matches a predetermined signal or not before sending signal to force the motor to drive the mechanism to execute the locking or unlocking.

The next objective is to provide a start system controlling unit and a mobility system including an anti-theft alarm system for deactivating the operation of the start system and the mobility system so that they cannot function as usual. When the locking device is in a locked state and when an automobile stealing is detected, the anti-theft alarm system will actuate the siren to emit sounds so as to call attention of people nearby the automobile or send a radio signal or makes a telephone call to inform the owner of the automobile, persons or organizations concerned.

The next objective is to provide a casing for electric-electronic circuits in a main control section, namely a decoder circuit, a control circuit and a drive circuit, and a locked and unlocked state sensor section including a section where there is a connection by metal between the internal circuits in the main control section to a motor so as to prevent destruction or tampering of such circuit connection.

The next objective is to provide an individual encoder device/circuit and a decoder circuit for resetting the operation of the start system controlling unit and the mobility system including the anti-theft alarm system when any part of an electrical-electronic system in a main control section or a motor cannot be function normally so that a start system and a mobility system can return to their normal states. The owner of the automobile can then apply a key to the lock to unlock and bringing the drive mechanism out of a locked state and make the steering wheel able to turn as usual.

The last objective is for, in addition to their application to automobiles, applying the system and device for locking an automobile steering axis according to this invention to other type of vehicles having steering axis. This objective can be achieved by a drive mechanism specifically designed for the steering axis of a particular vehicle and by the electric-electronic circuit according to the invention which controls a motor to force the drive mechanism to execute the locking or unlocking.

### BRIEF DESCRIPTION OF DRAWINGS

FIG. 1 is a block diagram of the system and device for locking an automobile steering axis according to the present invention.

FIG. 2. Shows one feature of an installation of a collet 40 to an automobile steering axis.

FIG. 3. Shows one feature of an installation of the present invention for cooperating with a collet 40 attached to an automobile steering axis.

FIG. 4 shows one feature of a collet 40 and a collet jacket 32 in an unlocked state.

FIG. 5 shows one feature of a collet 40 and a collet jacket 32 in a genuine locked state.

FIG. 6 shows one feature of a collet 40 and a collet jacket 32 in another locked state.

FIG. 7 shows many embodiments of a collet 40 and a collet jacket 32 of the locking device according to the present invention.

FIG. 8 still shows many embodiments of a collet 40 and a collet jacket 32 of the locking device according to the present invention.

FIG. 9 shows another embodiment of a collet 40 and a collet jacket 32 of the locking device according to the present invention.

FIG. 10 shows another feature of a locking of a collet 40 and a collet jacket 32 in FIG. 9.

FIG. 11 shows another embodiment of a collet 40 and a collet jacket 32 according to the present invention.

FIG. 12 shows another feature of a locking of a collet 40 and a collet jacket 32 in FIG. 11.

FIG. 13 shows another embodiment of a collet 40 and a collet jacket 32 of the locking device according to the present invention.

FIG. 14 shows an operation of the collet 40 and the collet jacket 32 in FIG. 13.

FIG. 15 shows front and back views of the collet 40 and the collet jacket 32 in FIG. 13 in an actual locked state.

FIG. 16 shows the members of the drive mechanism 7 and the motor of the automobile steering axis locking device according to the present invention.

FIG. 17 shows partial views of the drive mechanism 7 and the lock 8 which compare the invention in normal state (17A) and when using a key 9 to unlock the lock 8 (17B) in case any part of the electric-electronics or motor cannot be operated.

FIG. 18 shows another embodiment of the sliding axis 31.

FIG. 19 shows an embodiment of the automobile steering axis locking device according to the present invention after the members in FIG. 16 are assembled and the main control section 18 is assembled inside the outer cylinder 37.

FIG. 20 shows the member of the mechanism inside the outer cylinder 37 after the members in FIG. 16 are assembled.

FIG. 21 shows another feature of the members of drive mechanism 7

FIG. 22 shows the embodiment of the drive mechanism 7 and motor 6 after the members in FIG. 21 are assembled.

FIG. 23 shows the embodiment of the attachment members 28 attached to the cylinder covering the steering shaft.

FIG. 24 shows the embodiment of the attachment member 28 attached to the brake pedal attachment base.

FIG. 25 shows another embodiment of the attachment member 28 attached to the brake pedal attachment base.

FIG. 26 shows another embodiment of the attachment member 28 attached to the cylinder covering the steering shaft.

FIG. 27 shows another feature of the members of drive mechanism 7.

FIG. 28 shows another feature of the members of drive mechanism 7.

FIG. 29 shows an embodiment of the steering axis of the automobile according to the present invention after the members in FIG. 27 are assembled.

FIG. 30 shows an embodiment of the steering axis of the automobile according to the present invention after the members in FIG. 28 are assembled.

### DETAILED DESCRIPTION OF THE INVENTION

The system and device for locking an automobile steering axis is a device for locking the automobile steering axis so that steering wheel is unable to turn. An electrical-electronic system and a mechanical system are provided to facilitate the execution of the locking and unlocking instead of a manual locking and unlocking mechanism. The device is provided with a motor as a power source controlling the drive mechanism to carry the collet jacket to cover the collet in order to execute a locking operation or controls the drive mechanism to carry the collet jacket from the collet to execute an unlocking operation upon receiving a signal from the electrical-electronic system.

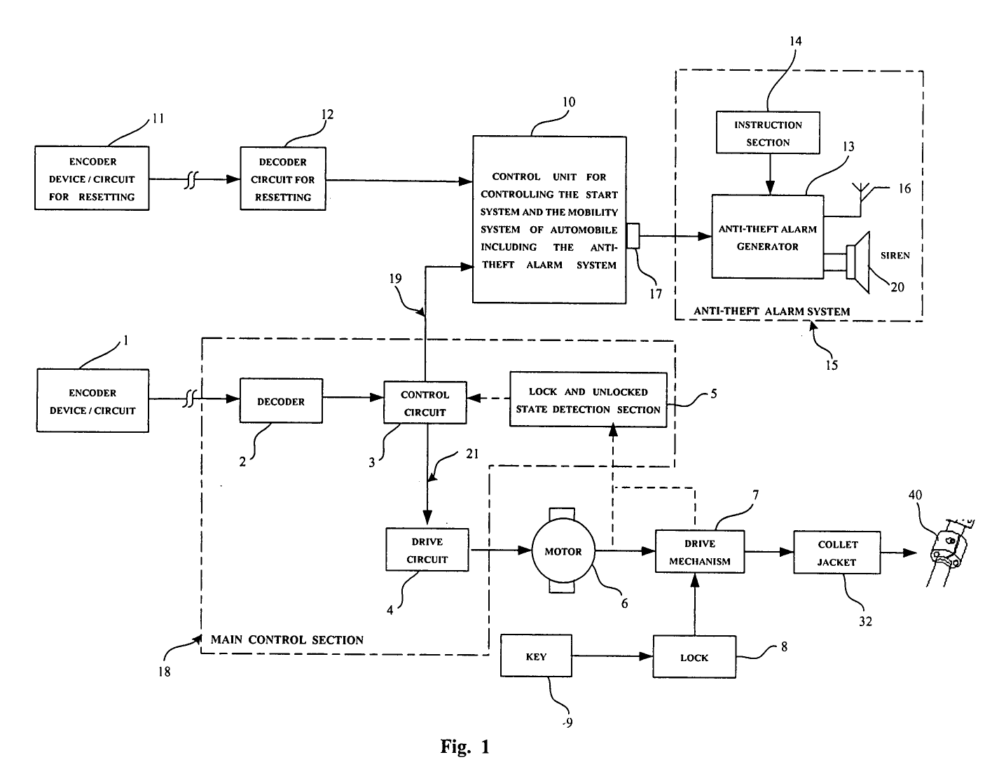

FIG. 1 shows a block diagram of the System and device for locking an automobile steering axis according to the invention. In the figure, this invention comprises two main parts: an electrical-electronic system part and a mechanical part. The electrical-electronic system comprises at least an encoder device/circuit 1, a main control section 18, a motor 6, an encoder device/circuit for resetting11, a decoder circuit for resetting 12 and a control unit 10 for controlling the start system and the mobility system of automobile including the anti-theft alarm system. The anti-theft alarm system 15 is also connected to a signal channel 17 of the control unit 10 for enhancing the efficiency in preventing stealing. The anti-theft alarm system comprises at least an anti-theft alarm generator 13, an instruction section 14 which sets the anti-theft alarm system into an alarm-ready mode or a disalarm-ready mode, a siren 20 which emits sound for attracting the attention of people nearby when an unusual incident has occurred, and antenna 16 which sends the radio signal or makes a telephone call to inform the owner of the automobile, persons or organizations concerned to inform such persons of the unusual incident occurring to the automobile. The mechanical part comprises at least a drive mechanism 7, a lock 8, a key 9, a collet jacket 32 and a collet 40 which each component has manner and operation method as described below.

The function of the encoder device/circuit 1 is to encode a signal to direct the invention to lock and unlock. Then a code signal is sent to the main control section 18 to perform according to the received signal. Such encoder device/circuit including the encoder device/circuit for resetting 11 generates or defines a specific code for each locking device. The encoding is carried out by using the basic electronic circuit, IC packet, keyboard, RFID (Radio Frequency Identification Transponder) system, biometric system (fingerprint, eye or face authentication); by pressing the key of telephone or DTMF (Dual Tone Multi Frequency) or by sending the SMS (Short Message); or other encoding methods which can be performed by persons of ordinary skills in the arts. This is not considered to be departing from the scope of the present invention. The encoding may use one of the systems or a combination thereof. As for the method for sending code signals to the decoder circuit according to the invention, it is possible to use a wired or wireless signaling such as the code signaling by a remote controller, by light or radio wave as a carrier, for example.

The main control section 18 comprises at least a decoder circuit 2 which compares the code signal received from the encoder device/circuit 1 with a predetermined code before sending the signal to the control circuit 3; a control circuit 3 which sends a signal 19 to the control unit 10 for controlling the operation of the start system and the mobility system and also sends a signal from channel 17 to the anti-theft alarm system 15 connected to the invention to set the system into an alarm-ready mode or disalarm-ready mode, and sends the control signal 21 to the drive circuit for controlling the operation of the motor; a drive circuit 4 which amplifies and formats the signal received for controlling motor to turn the drive mechanism 7; and a lock and unlocked state detection section 5 which comprises at least a detecting device or sensor circuit for determining whether the rotation cycle or the rotation distance of motor 6 or the position of the drive mechanism 7 is the position of locked or unlocked state or not by comparing the electrical current used for driving the motor and/or by counting rotations and/or by receiving of signal about the position of locked and unlocked state of the drive mechanism 7 from the detecting device. When it is determined that the locking device is in a locked or unlocked state, a signal is sent to the control circuit 3 for controlling the operation of the motor.

In addition, the invention is also applicable to a micro-controller or a integrated circuit (IC) specially designed to replace the main control section 18. When such micro-controller or IC receives a code signal from the encoder device/circuit 1, the code signal is compared whether it matches the predetermined code or not. If they match, a processing will be carried out to send the signal to the control unit 10 and a signal is sent to control the operation of the motor including determining whether the number of the rotation cycles or the rotation position of the motor 6 or the position to which the drive mechanism 7 has moved is the position of locked or unlocked state or not by comparing the current used for driving the motor and/or counting the number of the rotation cycles of the motor and/or receiving of signal from such monitoring device when the position of locked and unlocked state of the drive mechanism 7 is detected.

The above mentioned motor 6 and main control section 18 including an electrical wiring section connected from the circuit within the main control section to the motor 6 are encased with metal for preventing destruction or tempering of connections of circuit, for example, bringing a wire from the other power sources to directly connect to the motor. Such encasing refers to an electrical wiring of such motor 6 and main control section 18 so as to be assembled and encased with metal and then mounted on drive mechanism 7, or refers to an electrical wiring of such motor 6 and main control section 18 so as to be assembled and encased with metal and then mounted on drive mechanism 7 and encased again, or the main control section 18 including electrical wire connected to motor 6 are encased separately from the motor 6. This is not considered to be departing from the spirit and the intention of the present invention.

The control unit 10 for controlling the start system and the mobility system of the automobile including the anti-theft alarm system controls the operation of the start system and the mobility system of an automobile so that they cannot function as usual when the locking device according to the invention in the locked state. The control unit 10 also sends a signal through the channel 17 to the anti-theft alarm system 15 to set the system into the alarm-ready mode when the invention is in the locked state or cancel the ready mode when the invention is in the unlocked state. When the signal cable connected from the internal circuit within the main control section 18 to the control unit 10 is cut off or shorted-circuit, such control unit will send the signal to the anti-theft alarm generator 13 of the anti-theft alarm system 15 to activate the generator to send the signal to actuate the siren to emit a loud sound for attracting the attention of the people nearby and sends a radio signal or makes a telephone call to inform the owner of the automobile, persons or organizations concerned to inform the occurrence of the unusual incident. The cooperation of the locking device according to the invention and the above anti-theft alarm system is enable the invention to detect an unusual incident such as the stealing of automobiles by monitoring the temperature and the motion in the automobile, an opening of doors, vibration including various means of detection capable of detecting and signaling an intrusion into the automobile.

The above start system of the automobile according to the invention refers to a motor start, a solenoid, a relay, a relay cable, some parts of electric circuit in ECU, etc. The above mobility system of the automobile according to the invention refers to the electric transmission, the electric-controlled clutch, the electric-controlled brake, the electric-controlled fuel transfer system, the electric-controlled engine burning system, the electric accelerator, etc.

The encoder device/circuit for resetting 11 encodes the code for resetting when any parts of electrical-electronic system in the encoder device/circuit 1, the main control section 18 or the motor 6 cannot be operated. It then sends the code signal to the decoder circuit for resetting 12 to compare whether the received code matches the predetermined code or not. If they match, a signal is sent to the control unit 10 for controlling the start system and the mobility system of the automobile back to normal operation and to cancel the alarm-ready mode of the anti-theft alarm system 15.

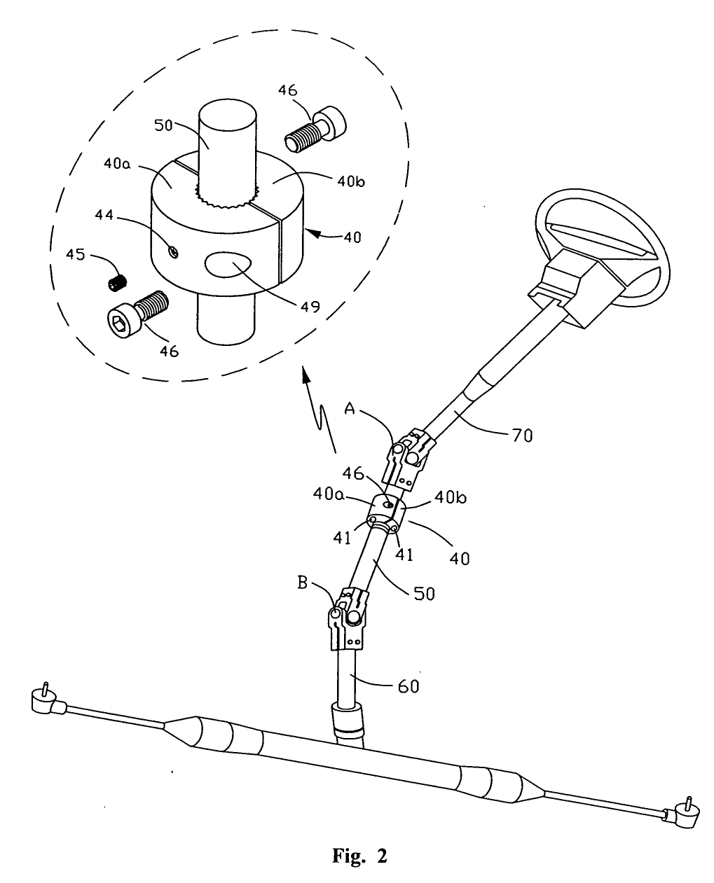

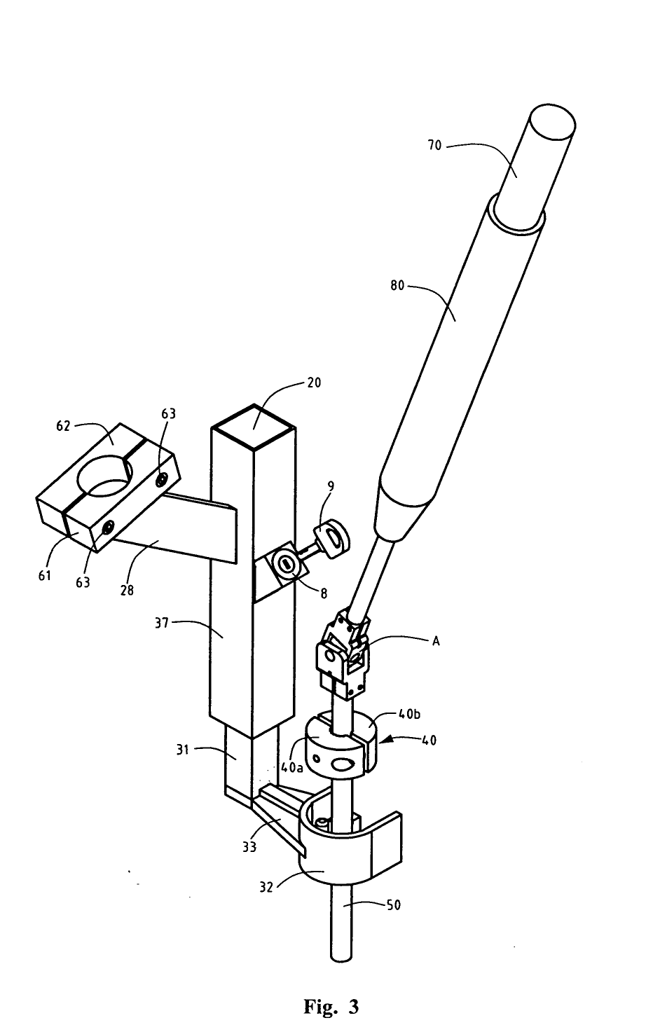

The drive mechanism 7 is provided for carrying the collet jacket 32 to cover the collet 40 to execute the locking or carrying the collet jacket 32 from the collet 40 to execute the unlocking, wherein the collet 40 is attached to the steering axis 50 of the automobile (see FIG. 2). In addition, the collet 40 can be attached to the steering axis 60 of the automobile or the steering shaft 70 based on the steering axis of each type and model of automobile. This is not considered to be departing from the scope of the present invention.

The lock 8 and the key 9 are used for unlocking operation in case any parts of the electrical-electronic system or motor 6 cannot be operated.

When the components of the electrical-electronic system and all above mechanism are assembled, the operations of the system and device for locking an automobile steering axis according to the invention are as follows: when the decoder circuit 2 of the main control section 18 receives the lock or unlock code signal from the encoder device/circuit 1, the received code is then compared to check whether it matches the predetermined code or not. If they match, the signal is sent to the control circuit 3 to activate the control circuit to output the signal 19 to the control unit 10 for controlling the start system and the mobility system of the automobile. When the invention is in a locked state, the control unit 10 controls the start system and the mobility system so that they cannot function as usual and sends a signal through the channel 17 to set the anti-theft alarm system 15 into the alarm-ready mode, thus the anti-theft alarm system can detect the unusual incident and perform the aforementioned functions.

In addition, the control circuit 3 also sends a signal to the drive circuit 4 for amplifying and formatting signals into an suitable form used to control the operation of the motor 6 to control the drive mechanism 7 to carry the collet jacket 32 to cover the collet 40 to execute the locking or to carry the collet jacket 32 from the collet 40 to execute the unlocking. While the motor 6 and the drive mechanism 7 is operating, the locked and unlocked state detection section 5 of the main control section 18 detects whether the position to which the drive mechanism 7 has moved or the rotation cycle of the motor 6 is the position that invention is in the locked or unlocked state or not. If the invention is in the locked or unlocked state, the locked and unlocked state detection section 5 will send a signal to the control circuit 3 for controlling the motor 6 to stop rotating. If the position of the drive mechanism 7 or the rotation position of motor 6 is not the locked or unlocked position, the locked and unlocked state detection section 5 will send the signal to the control circuit 3 for controlling the motor 6 to continuously rotate to the position which the invention is in the locked or unlocked state.

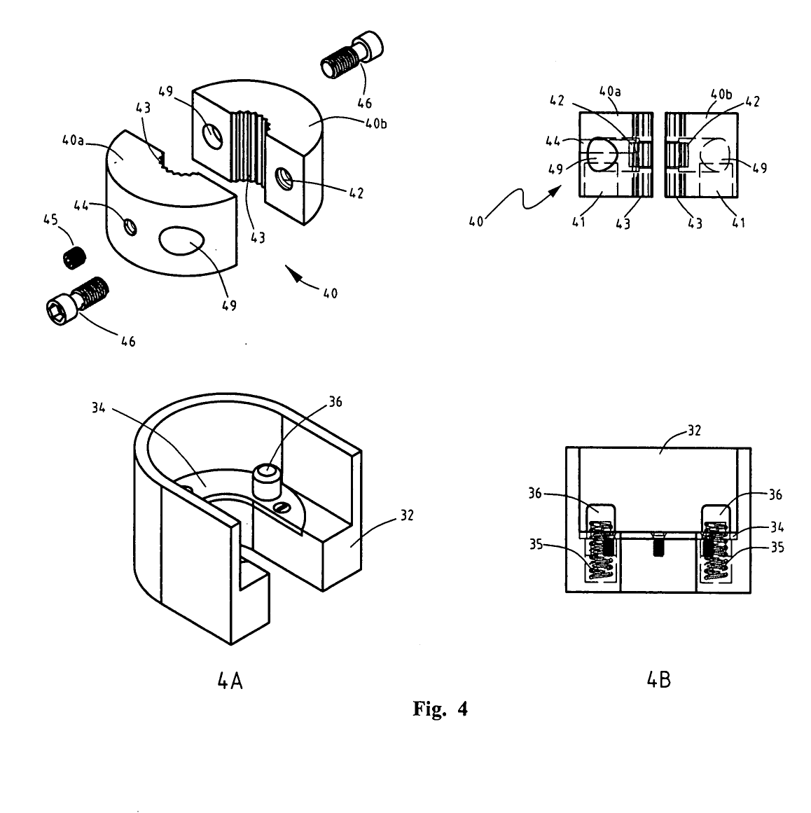

The above locked and unlocked state of the invention is generated due to the collet 40 and the collet jacket 32 as shown in FIG. 4. The structure of the collet 40 comprises at least a collet member 40a and a collet member 40b which each member is provided with a thread hole 42 and a hole 49 for inserting screw 46 to attach the members of the collet 40 together and the collet is securely attached to the steering axis. The lower surface of the collet 40 is provided with at least one lock hole 41 for engaging the lock latch 36 of the collet jacket 32. The surface area which contacts the steering axis 50 of a collet member 40a and a collet member 40b is provided with a streak groove 43. The thread hole 44 is provided for inserting the worm thread screw 45 so as to solidly attach the collet 40 to the steering axis 50. To prevent the slipperiness due to the twisting force or the turning force acting on the collet 40 (in this case, a slip occurs when the invention is in a locked state and a theft has invaded into the automobile. The theft may aggressively turn the steering wheel and the collet 40 is slipped out of the steering axis). The structure of the collet jacket 32 comprises at least one lock latch 36 for engaging with the lock hole 41 of the collet 40, a spring 35 for pushing the lock latch 36 into the lock hole 41. When the position of lock hole 41 is aligned with the position of lock latch 36, the locked state is achieved. There is provided a cover plate 34 to prevent the spring 35 and the lock latch 36 from moving apart from the collet jacket 32.

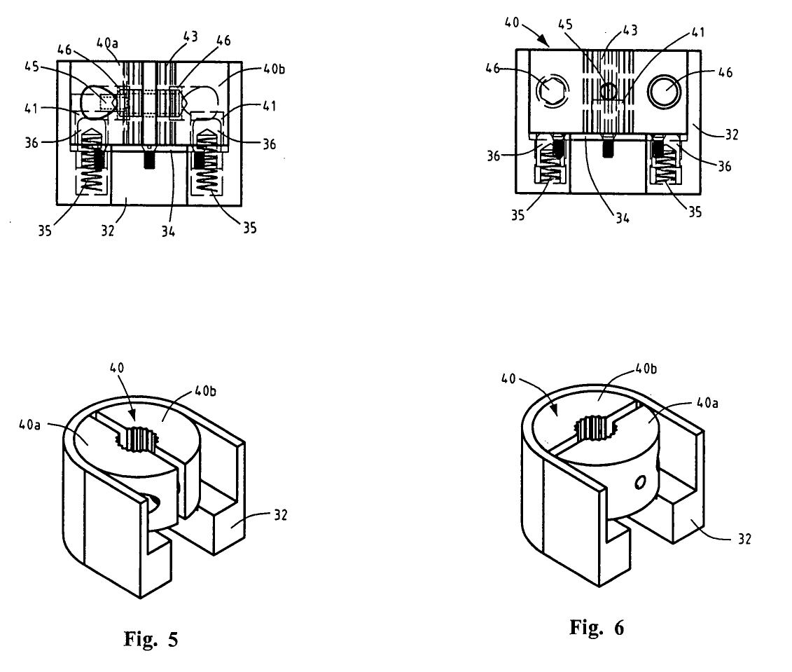

To facilitate better understanding of the characteristics of the collet 40 and the collet jacket 32 while they are in the locked state, an example in FIG. 5 and FIG. 6 is used as the example in conjunction with the following description. There are two manners of the locked state of the invention, that is, when the invention receives the code signal in order to execute the locking, the motor 6 drives the drive mechanism 7 to carry the collet jacket 32 to cover the collet 40, thereby the spring 35 of the collet jacket 32 pushes the lock latch 36 into the lock hole 41 of the collet 40 resulting in that the steering wheel unable to turn as usual. The said state is called “the genuine locked state” which occurs when the position of lock hole 41 is aligned with that of the lock latch 36 as shown in FIG. 5. The another locking manner according to the invention is that when the invention receives the code signal in order to execute the locking, the motor 6 drives the drive mechanism 7 to carry the collet jacket 32 to cover the collet 40 but the lock latch 36 of the collet jacket 32 is pressed by the side surface of a collet member 40a or a collet member 40b of the collet 40 as shown in FIG. 6. Such state is assumed to be locked state according to the invention. This locked state occurs because of the position of lock hole 41 is not aligned with that of the lock latch 36, making the steering wheel able to turn in some extent. But when the steering wheel is turned until the position of lock hole 41 is aligned with that of the lock latch 36, the spring 35 of the collet jacket 32 will push the lock latch 36 into the lock hole 41 of the collet 40, therefore the steering wheel unable to turn as usual.

Both manners of the locked state results from providing the collet 40 with the lock hole 41 and the collet jacket 32 is in the form of socket perfectly fitted with the collet 40. The collet jacket 32 is also provided with the lock latch 36 which cooperates with the spring 35, thereby even when the collet jacket 32 tightly covers the collet 40, but the position of lock hole 41 is not aligned with that of the lock latch 36, the invention can also execute the locking. That is, such collet itself rotates within the covering socket of the collet jacket 32. Accordingly, when the steering wheel is turned, the collet 40 will rotate correspondingly, thereby the position of lock hole 41 is aligned with that of the lock latch 36 and the spring 35 will push the lock latch 36 into the lock hole 41, bringing the locking device into a genuine locked state. Therefore, the user of the Anti-theft alarm system according to the present invention does not have to pay attention whether the lock hole 41 of the collet 40 is aligned with the lock latch 36 of the collet jacket 32 in the locked state or not. The user is therefore confident that the invention can lock the steering wheel such that the steering wheel cannot be turned.

From the above description, it is apparent that the design of such collet jacket 32 and the collet 40 does not required the user to apply both hands when he/she desires to lock the locking device according to the invention (In the use of the automobile steering axis locking device with only the mechanical system, both hands are required for the locking operation by using one hand to turn the steering wheel until the position of the collet jacket and the collet with angle are perfectly align and completely covered one another and the other hand is used to pull the part provided to be pulled up in order to execute the locking so the collet jacket and the collet locks each other fittingly. Such locking method is very difficult and complicated for a users to lock the automobile steering axis.)

Apart from providing the collet jacket 32 and the collet 40 with the above structure, the structure of some parts may be modified within the same principle, that is, to be able to securely lock the steering axis. This is not considered to be departing from the scope of the present invention. The examples of the improvement of the structure of the collet jacket 32 and the collet 40 are as follows.

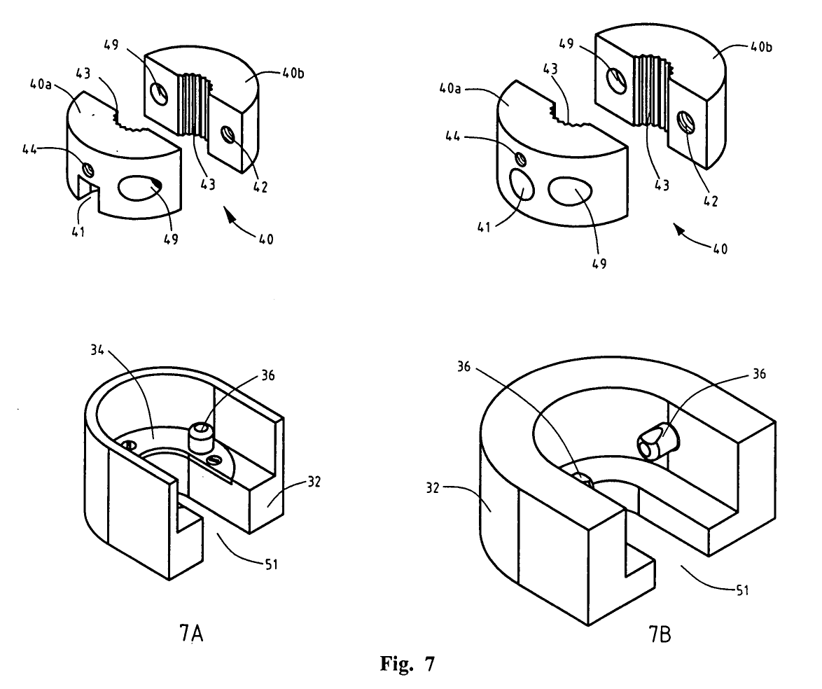

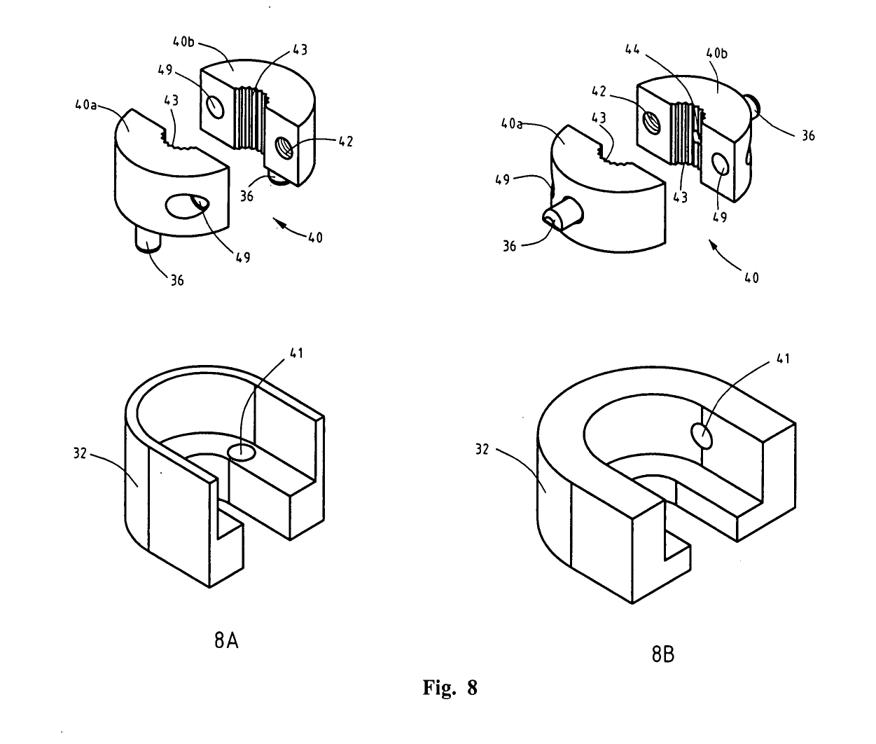

FIG. 7A shows another embodiment of the collet jacket 32 and the collet 40. The structure of the collet 40 is provided with at least one lock groove 41 for engaging the lock latch 36 of the collet jacket 32 with the lock groove in order to execute the locking, wherein the structure of the collet jacket 32 is the same as those shown in FIG. 4.

FIG. 7B shows another embodiment of the collet jacket 32 and the collet 40. The structure of the collet 40 is provided with at least one lock hole 41 on the side of a collet member 40a or a collet member 40b and the structure of the collet jacket 32 is provided with at least one lock latch 36 for engaging with the lock hole 41 of the collet 40. The lock latch 36 and spring 35 are arranged on the side surface of the collet jacket 32.

FIG. 8A shows another embodiment of the collet jacket 32 and the collet 40. The structure of the collet 40 is provided with at least one set of the lock latch 36 and the spring 35 in order to execute the locking, wherein the lock latch protrudes into the lower part of a collet member 40a or a collet member 40b. The structure of the collet jacket 32 is provided with at least one lock hole 41 so that the spring 35 can push the lock latch 36 into such lock hole in order to execute the locking.

FIG. 8B shows another embodiment of the collet jacket 32 and the collet 40. The structure of the collet 40 is provided with at least one set of the lock latch 36 and the spring 35 in order to execute the locking, wherein the lock latch protrudes to the side of a collet member 40a or a collet member 40b. The structure of the collet jacket 32 is provided with at least one lock hole 41 so that the spring 35 can push the lock latch 36 into the lock hole in order to execute the locking.

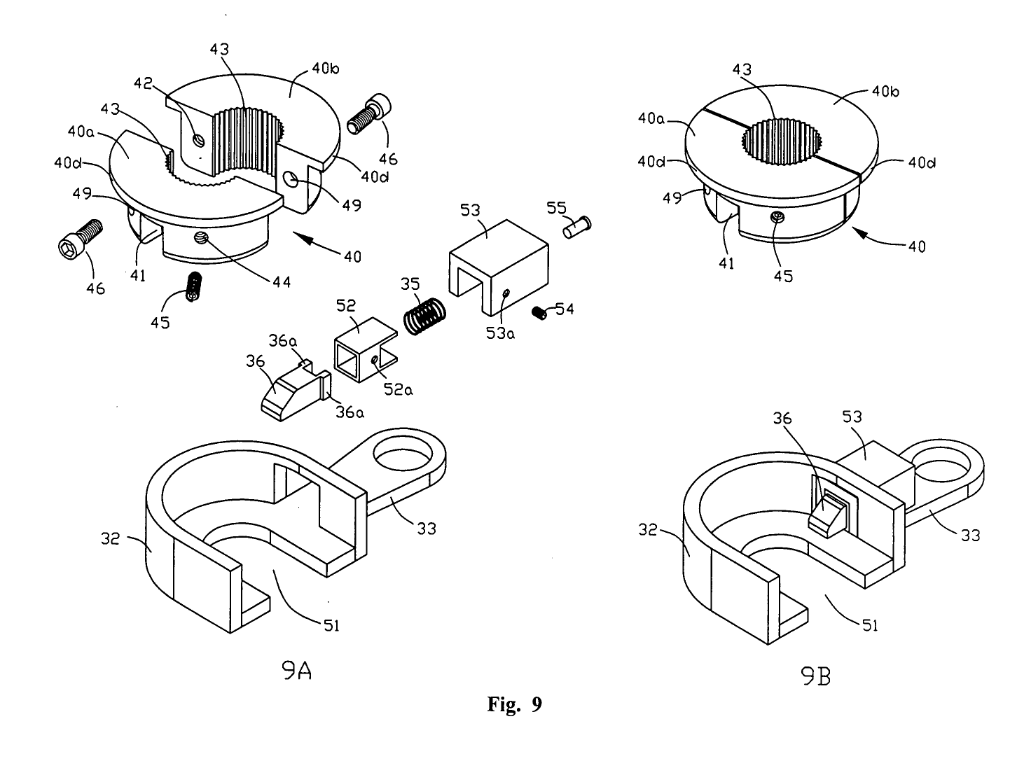

FIG. 9A shows another embodiment of the collet jacket 32 and the collet 40. The structure of the collet 40 comprises at least a collet member 40a and a collet member 40b which each member is provided with a thread hole 42 and a hole 49 for inserting the screw 46 to attach the members of the collet 40 together. The screw makes the collet 40 securely attach to the steering axis of the automobile. The side surface area of a collet member 40a or a collet member 40b is provided with at least one lock groove 41 for engaging the lock latch 36 of the collet jacket 32 to execute the locking. The surface area of the collet which contacts the steering axis 50 of a collet member 40a and a collet member 40b is provided with a streak groove 43 and a thread hole 44 for inserting the worm thread screw 45 for more securely attaching the collet 40 to the steering wheel 50. In addition, the upper part of collet member 40a and a collet member 40b are provided with a flange 40d protruding to close the upper part of collet jacket 32 while the collet jacket is covering the collet 40 (while the invention is in a locked state) to prevent the lock latch 36 from being forced or and picked to open.

The structure of the collet jacket 32 is in from of a covering socket fitting with the collet 40 and is provided with a U-shaped notch 51 to avoid the steering wheel 50. The collet jacket is connected to the arm 33 of the drive mechanism. The collet jacket has at least one lock latch 36 for pierce-engaging into the lock groove 41 of the collet 40. The lock latch is provided with a flange 36a protruding from both sides, a bush 52 for preventing the lock latch 36 from moving apart from the casing part 53 and a thread hole 52a for inserting a worm thread screw 54 to attach to the casing part 53, a spring 35 for pushing the lock latch 36 into the lock groove 41 so as to move into a genuine locked state when the position of lock groove 41 is aligned with that of the lock latch 36, and the casing part 53 for encasing some parts of the lock latch 36. The bush 52 and the spring 35 are to prevent destruction or removal of internal parts. Such casing part is provided with a hole for fitting the spring controlling axis 55 to control the spring not to be decentered and provided with a thread hole 53a for inserting the worm thread screw 54 to securely attach the bush 52 to the casing part 53.

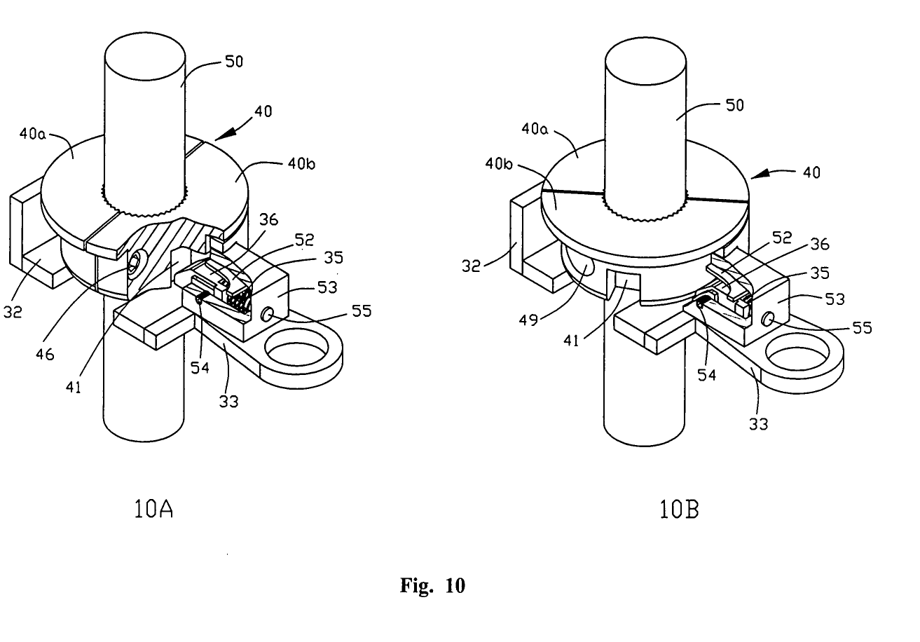

When the members as shown in FIG. 9A are assembled, its features is the same as shown in FIG. 9B. When the locking device according to the invention with the features of the collet jacket 32 and the collet 40 as shown in FIG. 9 is installed in the automobile, the user can execute the locking which makes the steering wheel unable to be turned to control the direction of the automobile since the lock latch 36 is engaged with the lock groove 41 of the collet 40 as shown in FIG. 10A. Even if the position of lock latch 36 of the collet jacket 32 is not aligned with that of the lock groove 41 of the collet 40 as shown in FIG. 10B, it is also considered that the locking device according to the invention is in the locked state, because when the steering wheel is turned the steering axis 50 also turns correspondingly. Thus the collet 40 attached to the steering axis turns within the covering socket of the collet jacket 32. This makes that the lock groove 41 move to the position corresponding to the position of the lock latch 36 and thus the locking device is in a genuine locked state.

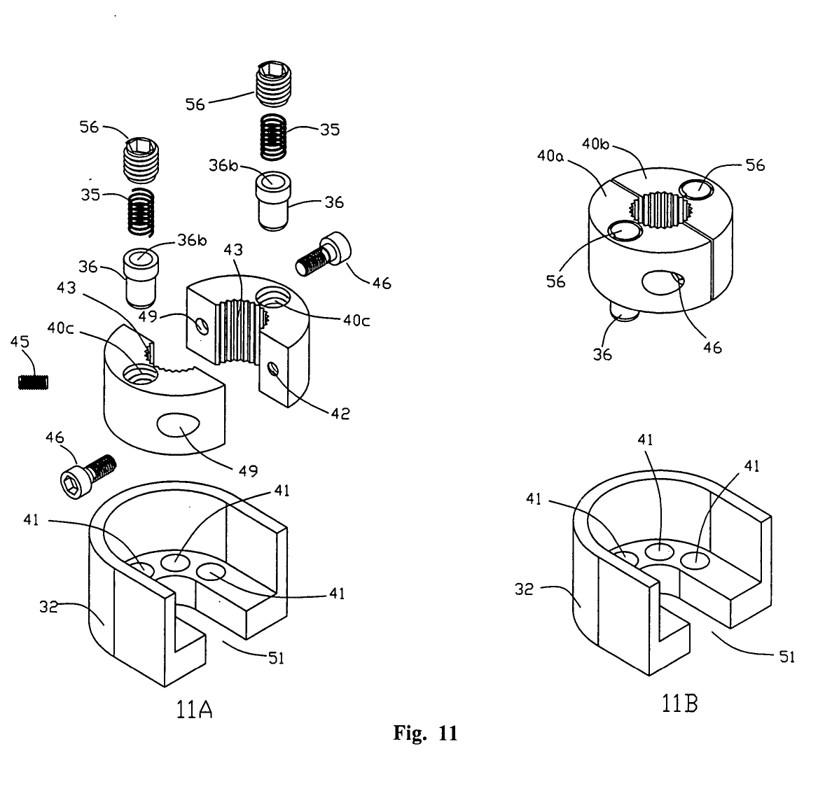

FIG. 11A shows another embodiment of the collet jacket 32 and the collet 40. The structure of the collet 40 comprises at least a collet member 40a and a collet member 40b, each member being provided with a thread hole 42 and a hole 49 for inserting the screw 46 to attach the members of collet 40 together in which also helps make the collet 40 securely attach to the steering axis of automobile, a hole 40c for engaging the lock latch 36 and a spring 35. The upper of hole is provided with a female screw for inserting a male screw 56 into the hole for closing it to prevent the lock latch 36 and the spring 35 from moving apart from the collet 40. When the male screw 56 is already inserted, the head of screw is destroyed as shown in FIG. 11B to prevent such screw from unscrewing out by tools. The surface area which contacts the steering axis 50 of a collet member 40a and a collet member 40b is provided with a streak groove 43 and a thread hole 44 for inserting the worm thread screw 45 to securely attach the collet 40 to the steering axis 50. The structure of the collet jacket 32 is provided with a covering socket which fit the collet 40 and a U-shaped notch 51 to avoid the steering axis 50. The collet jacket is provided with at least one lock hole 41.

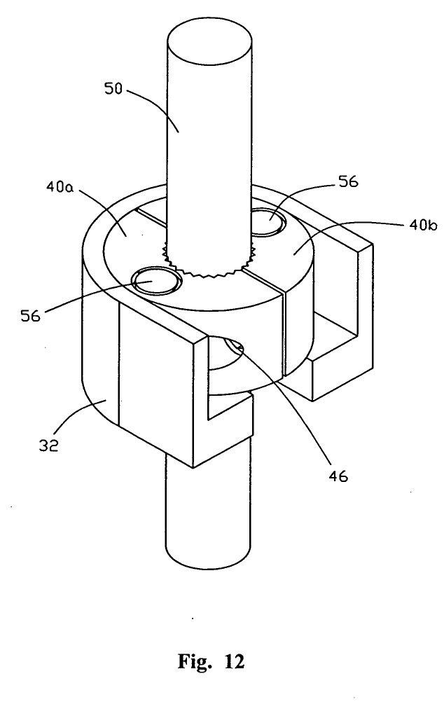

When the members as shown in FIG. 11A are assembled, its feature is the same as shown in FIG. 11B. When the locking device according to the invention with the features of the collet jacket 32 and the collet 40 as shown in FIG. 11 is installed in the automobile, the user can execute the locking to make the steering wheel unable to be turned to control the direction of the automobile since the lock latch 36 is engaged with the lock groove 41 of the collet 40 as shown in FIG. 12.

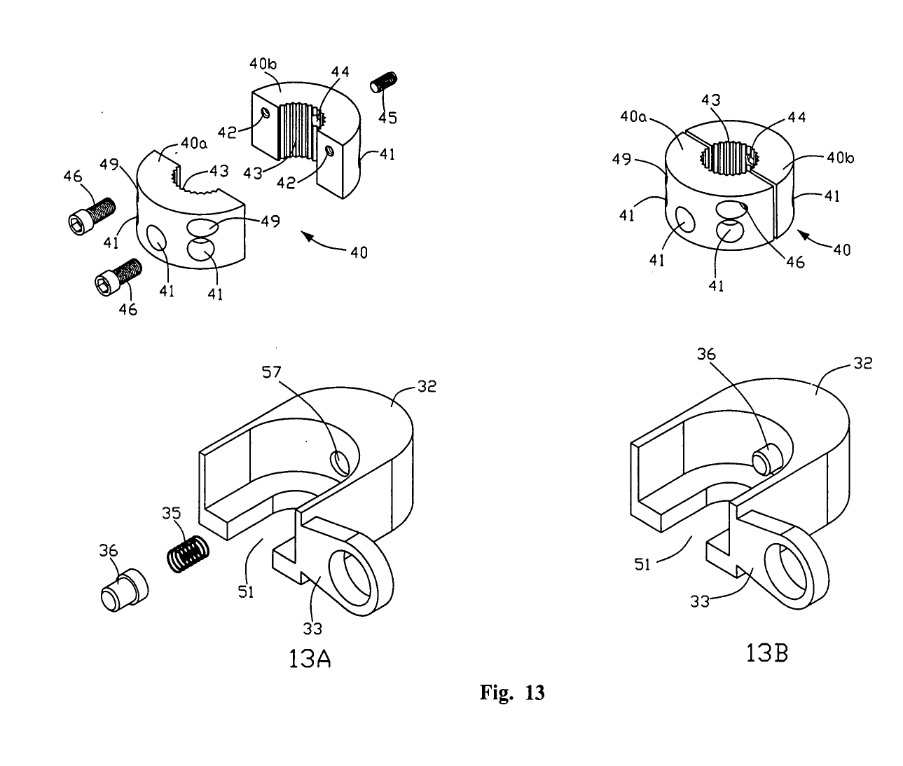

FIG. 13A shows another embodiment of the feature of the collet jacket 32 and the collet 40. The structure of collet 40 comprises at least a collet member 40a and a collet member 40b which each member being provided with a thread hole 42 and a hole 49 for inserting a screw 46 to attach the members of collet 40 together. Such screw also helps make the collet 40 securely attach to the steering axis. The side surface of collet is provided with at least one lock hole 41 to enable the engagement of the lock latch 36 of the collet jacket 32 with the hole to execute locking. The surface area which contacts the steering axis 50 of a collet member 40a and a collet member 40b is provided with a streak groove 43 and a thread hole 44 for inserting the worm thread screw 45 so that the collet 40 can be more securely attached to the steering axis 50. The structure of collet jacket 32 is in the form of a covering socket which fit with the collet 40 and is provided with a U-shaped notch 51 to avoid the steering axis 50. The collet jacket is connected to the arm 33 of the drive mechanism which is provided with at least one lock latch 36 for penetrating to the lock groove 41 of the collet 40. The lock latch is provided with a spring 35 for pushing the lock latch 36 to engage with the lock groove 41 in a genuine locked state when the position of lock groove 41 is aligned with the position of lock latch 36. The lock latch and the spring are provided within the hole 57 of the collet jacket 32.

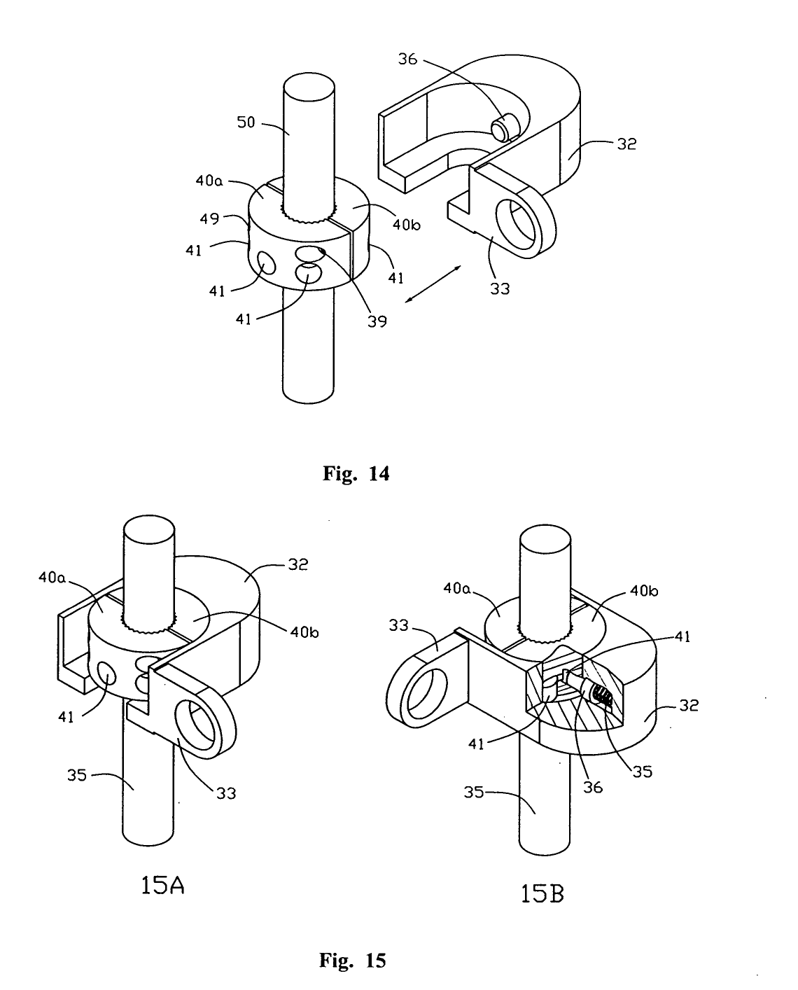

When the members as shown in FIG. 13A are assembled, its feature is the same as shown in FIG. 13B. When the locking device according to the invention with the features of the collet jacket 32 and the collet 40 as shown in FIG. 14 is installed in the automobile, the user can execute the locking to make the steering wheel unable to be turned to control the direction of the automobile since the lock latch 36 is engaged with the lock groove 41 of the collet 40 as shown in FIG. 15.

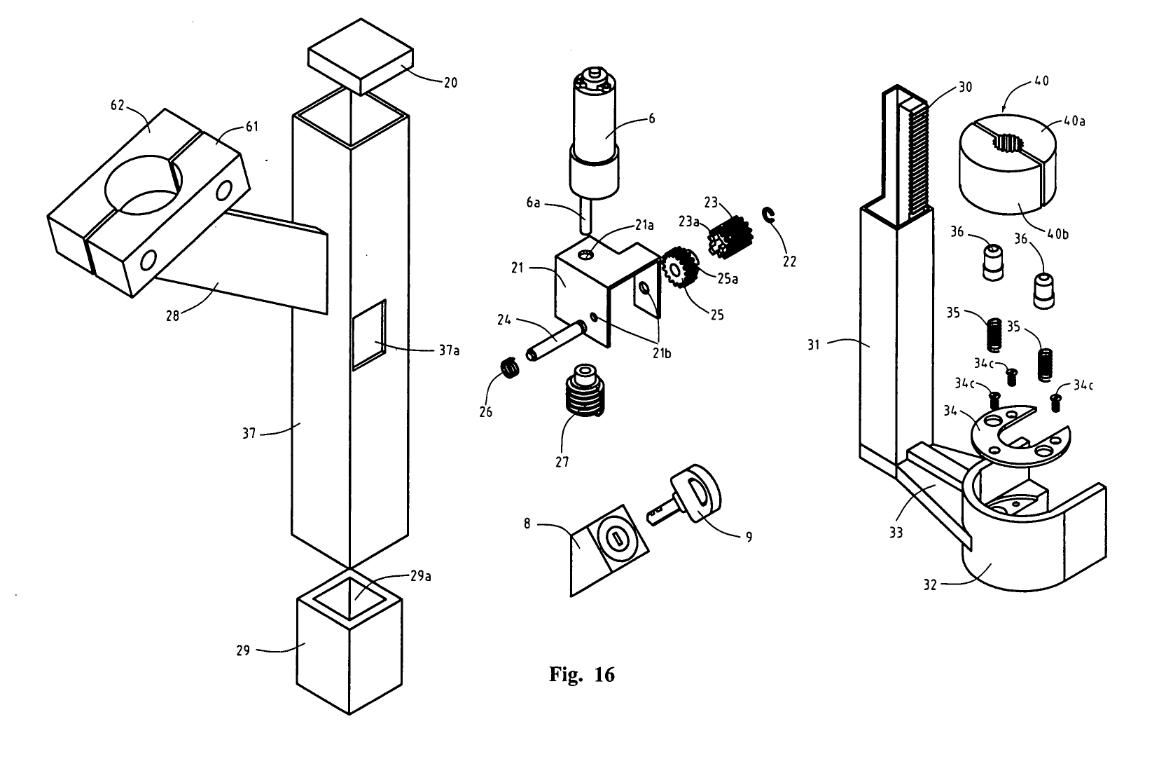

FIG. 16 shows one embodiment of the drive mechanism 7 which can function to lock and unlock the steering axis. The drive mechanism as shown in the figure is only one example of the invention and is not a limitation of the invention. In addition, the drive mechanism can be improved to suit the structure of each type and model of automobile. The electrical-electronic system according to the invention is used to control the operation of motor to drive the drive mechanism to carry the collet jack 32 to cover the collet 40 to execute the locking and carry the collet jack 32 from the collet in order to execute the unlocking.

The details of drive mechanism 7 in FIG. 16 are described below. The motor 6 is a device for transforming electric energy into mechanical energy to drive the gear set to rotate. The motor 6 is securely attached to the U-shaped metal plate 21 which is provided with a hole 21a for fitting the motor axis. The rotation shaft 6a of the motor is provided with a worm gear 27 mounted thereon to serve as a driving gear with the motor 6 as the power source and a hole 21b for fitting the shaft axis 24. The shaft axis 24 has a gear set mounted thereon. The gear set comprises a helical gear 25 and a spur gear 23 which serves as a driven gear to drive a rack 30 attached to the one end of the sliding axis 31. The other end of the sliding axis 31 is connected to the arm 33 with one end of the arm connected to the collet jacket 32. When the sliding axis 31 moves, the collet jacket 32 is moved correspondingly to lock or unlock the steering axis. The spur gear 23 is provided with at least one pivot 23a protruded for inserting into the notch 25a of the helical gear 25 to control both driven gears to rotate in the same direction. A lock washer 22 is provided for locking the shaft axis 24 so it does not move apart or move away from the U-shaped metal plate 21. A spring 26 is provided so that the helical gear 25 and the spur gear 23 do not move apart from each other, wherein one of the helical gear 25 is provided with a lock 8 for unlocking in case some parts or entire electrical-electronic system according to the invention can be not operated.

All of the above members and the control section 18 of the invention is encased in an outer cylinder 37 which is of cylindrical shape with a round or polygonal cross section, depending on the selected size of motor and the drive mechanism which is suitable for the structure of each type and model of automobile. The cover 20 is provided for closing one end of the outer cylinder 37 to prevent destruction of the internal parts and devices and the other end of the outer cylinder is mounted by the bearing member 29 and then securely connected together. The member is provided with the recess 29a to support the sliding axis 31 to move to lock or unlock accurately without shaking, swaying or decentering. An attachment member 28 is provided for attaching the lock device to the automobile permanently.

The attachment members have different shapes according to the installation method and depending on the structure of each type and model of automobile. The attachment members may be installed to the cylinder covering the steering shaft or the vicinity of the cylinder covering the steering shaft, the brake pedal attachment base, the body of the automobile or the structure of the automobile. The attachment member 28 as shown in FIG. 16 is one embodiment provided for attaching to the cylinder covering the steering shaft.

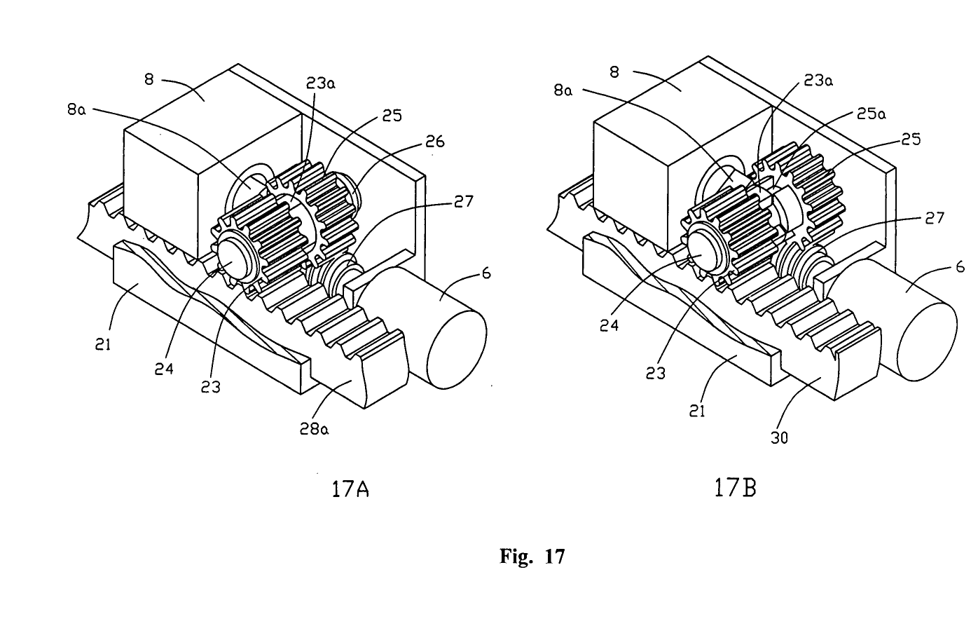

When one or more parts of the invention such as the encoder device/circuit 1 for instructing the invention to lock and unlock and/or the circuit within the main control section 18 and/or the motor 6 cannot be operated, the user can use the device/circuit for resetting 11 to encode and send a signal to the decoder circuit for resetting 12 to compare the received code with a predetermined code. If they match, a signal is sent to the control unit 10 so that the control unit terminates the operation, thus the start system and the mobility system of automobile is brought back to normal operation. A signal is output through the channel 17 to the anti-theft alarm system 15 for canceling the ready mode of the anti-theft alarm system. A key 9 is then used to unlock the lock 8 to control a cam set 8a of the lock to push the helical gear 25, to force the notch 25a of the helical gear out of the pivot 23a of the spur gear 23 as shown in FIG. 17B (see FIG. 17A). This releases the spur gear 23 and the rack 30 from the helical gear 25 and the person installing the locking device according to the invention can press or push the collet jacket 32 until it move apart from the collet 40, making the steering wheel able to be turned as usual.

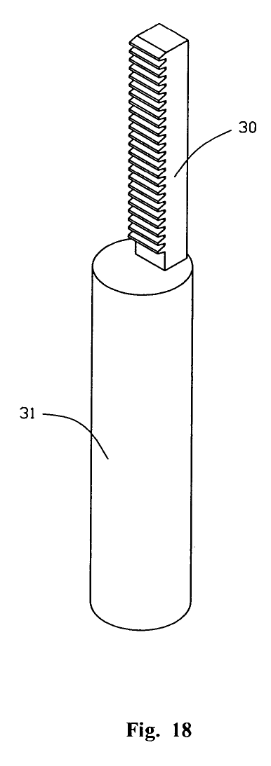

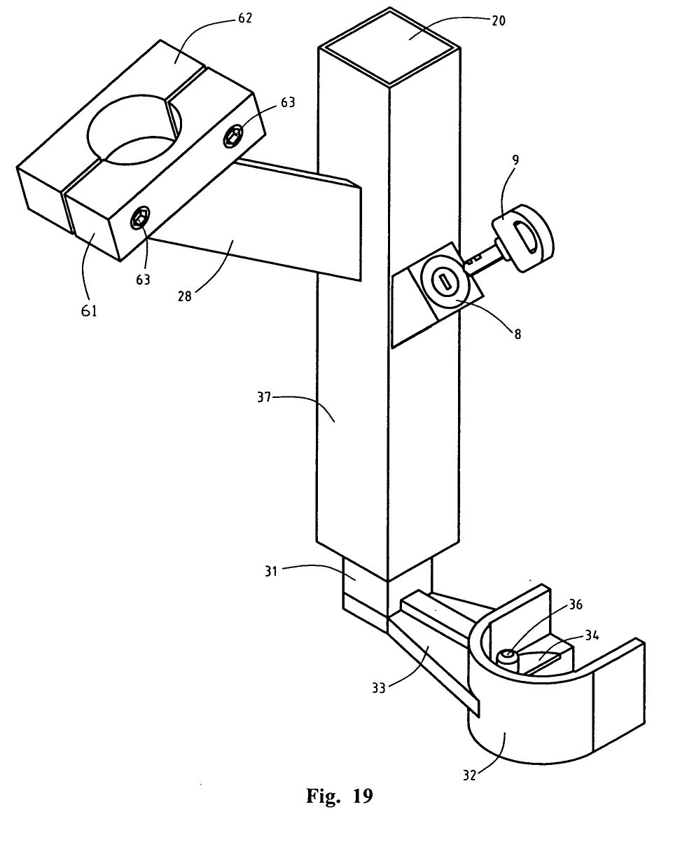

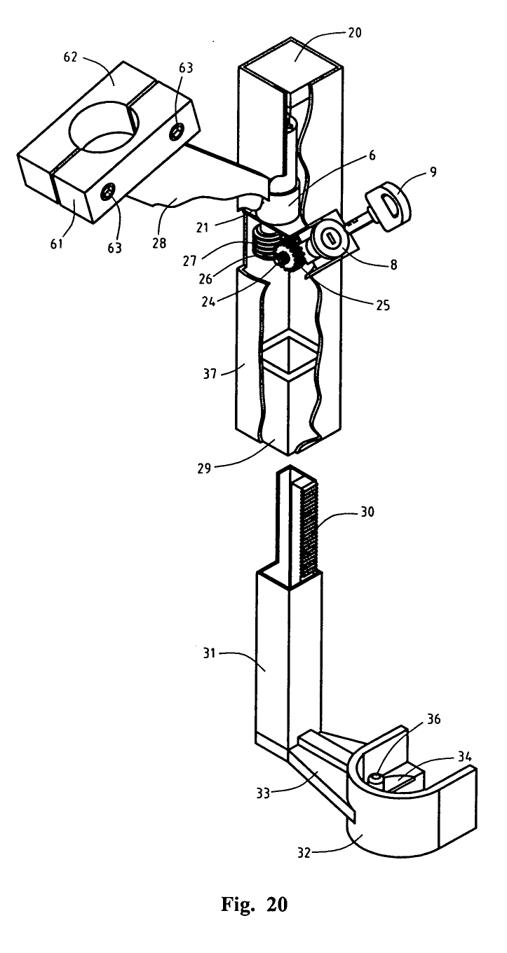

FIG. 18 shows another exemplary embodiment of the sliding axis 31 which can be applied in the invention. FIG. 19 and FIG. 20 show the Anti-theft alarm system and device. After the members of the drive mechanism 7 in FIG. 16 are assembled, the main control section 18 is mounted in the space within the outer cylinder 37 (not shown) provided that the specified position for installing the main control section does not block the operation of the mechanical system.

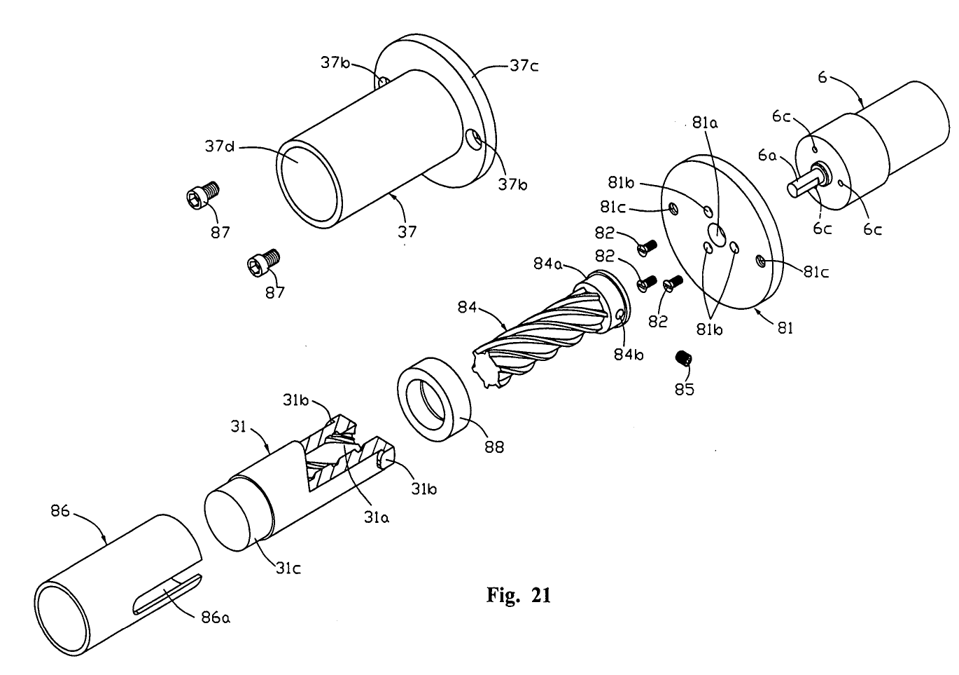

FIG. 21 shows another embodiment of the members of the drive mechanism 7 which comprises at least a metal plate 81 for attaching the motor 6. This metal plate is provided with a through hole 81a for inserting the rotation shaft 6a of motor 6, a through hole 81b for inserting the screw 82 into the thread hole 6c of motor for securely attaching the motor 6 to the metal plate 81. The metal plate 81 is provided with the thread hole 81c for inserting the screw 87 to securely attach the metal plate 81 to the flange 37c of the outer cylinder 37. The flange area is also provided with a hole 37b for inserting the screw 87 and the rotation shaft 6a of the motor is fitted with a spiral gear 84 or the so called spindle screw provided with a cone part 84a for mounting the bush 88. At the center of cone part 84a is provided with a hole for mounting to the rotating axis 6a of the motor and a thread hole 84b for inserting the worm thread screw 85 to securely attach the spiral gear 84 to the rotation shaft 6a of the motor.

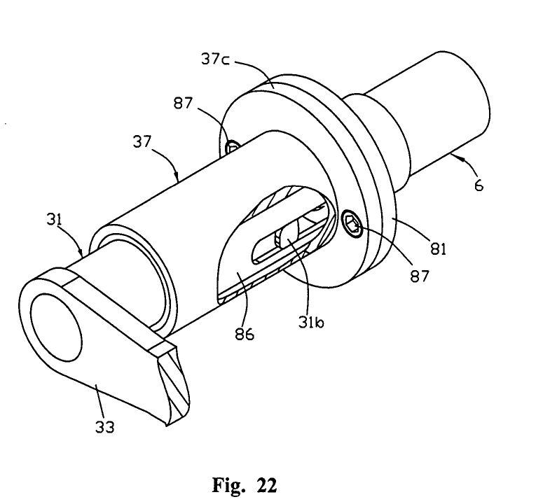

The above spiral gear 84 is fitted into the bush 88 to help supporting the cone 84a. Then, the spiral gear 84 is inserted into the thread hole 31a of the sliding axis 31. The thread hole has a set of teeth corresponding to the spiral gear 84. In addition, the sliding axis 31 is provided with at least one pivot 31b protruding to insert into the notch 86a of the metal cylinder 86 to prevent the sliding axis 31 which moves to lock or unlock from turning or twisting. The metal cylinder 86 is fitted into the recess 37d of the outer cylinder 37 and then connected together. The end 31c of the sliding axis is connected to the arm 33. The other end of the arm is connected to the collet jacket 32 (not shown). When the mechanical parts as shown in FIG. 21 are assembled and encased in the outer cylinder 37 as shown in FIG. 22, the operation is as follows: when the motor 6 receives a signal to perform the locking, it rotates to control the spiral gear 84 to rotates correspondingly. The sliding axis 31 with the thread hole 31a thereon then moves to carry the collet jacket 32 to cover the collet 40 in order to execute the locking, or when the motor 6 receives a signal to unlock, it rotates to control the spiral gear 84 to rotates correspondingly. Thus the sliding axis 31 then moves and carry the collet jacket 32 from the collet 40 to unlock.

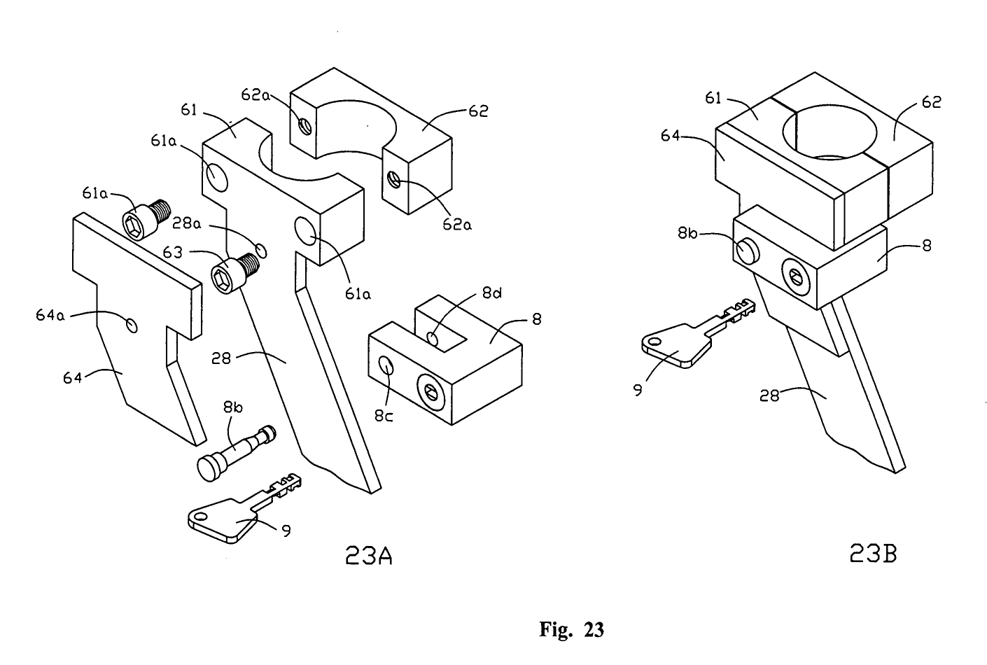

FIG. 23 shows one embodiment of the structure for attaching the invention to the cylinder covering the steering shaft and the method for incorporating the lock 8 to the structure. The attaching structure in this figure comprises at least an attachment member 28 which one end is connected to the outer cylinder 37 (not shown) and the another end is connected to an attacher 61. The attacher is formed with a concave which fits the cylinder covering the steering shaft and is provided with a hole 61a for inserting the screw 63 to attach the attacher 61 and the attacher 62 together. The attacher 62 is designed to be concave to fit the cylinder covering the steering wheel axis and is also provided with a thread hole 62a for inserting the screw 63.

After both attachers are assembled and attached to the cylinder covering the steering shaft as shown in FIG. 23B, the screw 63 is then inserted through the hole 61a and then this screw is tightened into the thread hole 62a. The screw cover plate 64 is assembled with the attachment member 28, wherein the hole 64a of the screw cover plate is aligned with the hole 28a of the attachment member 28 and the screw cover plate 64 will cover the screw head 63 to prevent the screw from unscrewing out. Then, the lock 8 is assembled with the attachment member 28 by inserting the lock shaft 8b through the hole 8c of the lock 8, the hole 64a of the screw cover plate 64, the hole 28a of the attachment member 28 and penetrating into the hole 8d of the lock 8 respectively. Completion of such operation brings the lock 8 into a locked state.

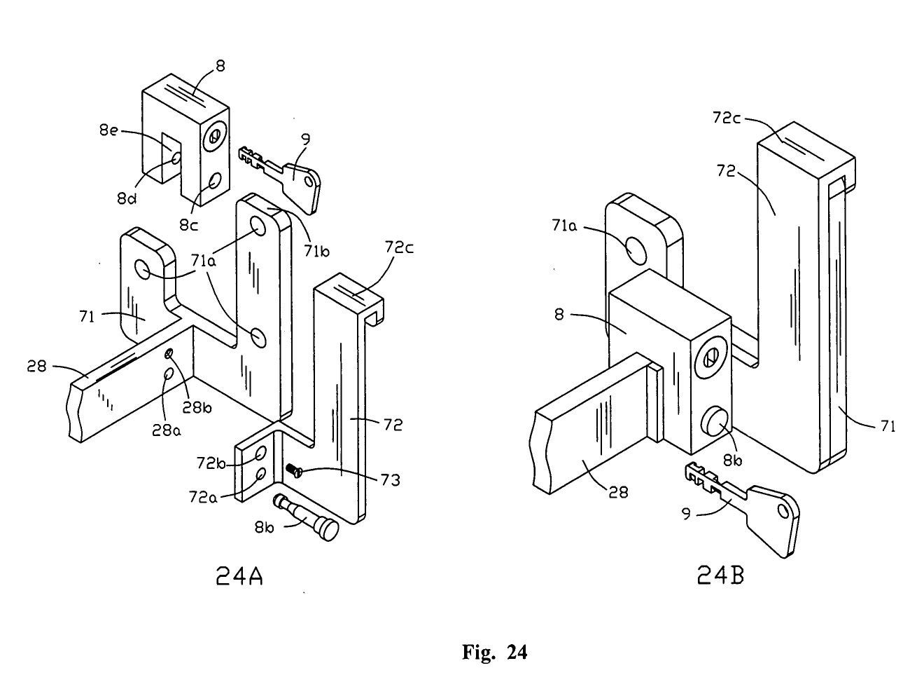

FIG. 24 shows one embodiment of the structure for attaching the invention to the brake pedal attachment base and the method for installing the lock 8 to the structure. The attaching structure in this figure comprises at least the attachment member 28 provided for attaching to the brake pedal attachment base. Its one end is connected to the outer cylinder 37 (not shown) and the other end is connected to the flange 71 with at least one hole 71 a thereon for fitting the male screw of the brake pedal attachment base. When the attachment member 28 connected to the flange 71 is installed to the brake pedal attachment base, the screw cover plate 72 is assembled on the flange 71 wherein the curved end 72c is engaged with the end 71b of the flange 71 and the hole 72a and the thread hole 72b of the screw cover plate is aligned with the hole 28a and the thread hole 28b of the attachment member 28 respectively. Then at least one screw 73 is inserted through the thread hole 72b and the hole 28b and such screw is then tightened solidly.

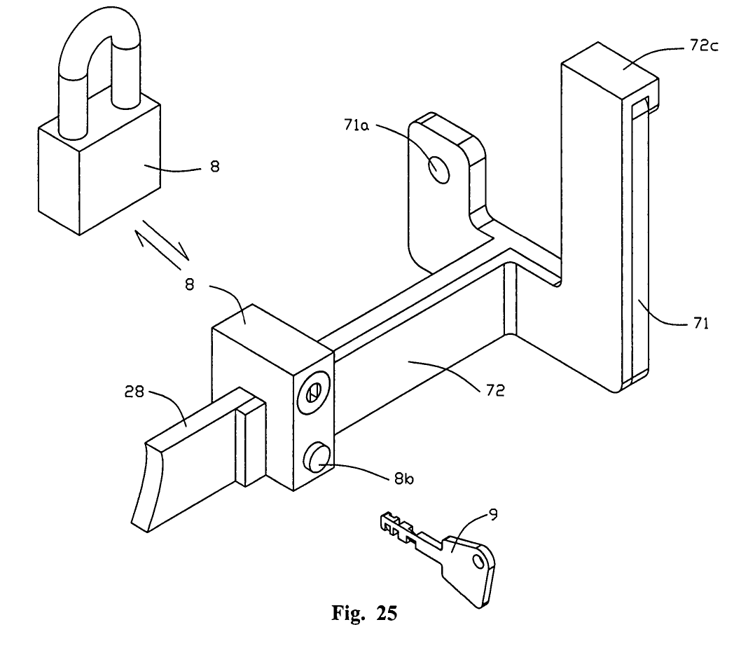

The lock 8 is assembled with the above parts, wherein the lock is a notch type lock 8e for mounting the attachment member 28 and the screw cover plate 72 to prevent both components from moving away from each other. After the lock 8 are assembled with both components, the lock shaft 8b can then be inserted into the hole 8c of the lock and passed through the hole 72a of the screw cover plate 72 and then passed through the hole 28a of the attachment member 28 and then penetrating into the hole 8d of the lock respectively. Completion of such operation brings the lock 8 into a locked state as shown in FIG. 24B. In addition, the lock applicable to the invention is a lock as shown in FIG. 23 and FIG. 24 or any other type of lock and the position for installing the lock may be any area of the attachment member 28 as shown in FIG. 25 and This is not considered to be departing from the scope of the present invention. The installation of the lock for attaching the screw cover plate 72 to the attachment member 28 to prevent them from moving away from each other makes that the screw cover plate 72 cover the screw 73 to prevent the screw from unscrewing out.

In FIG. 23, when the motor or the electrical-electronic circuit including the drive mechanism of the present invention do not function, the owner of the automobile can still use the key 9 to unlock the lock 8 and then pull out the lock latch 8b from the hole 8d of the lock 8, hole 28a of the attachment member 28 and the hole 64a of the screw cover plate 64 respectively. This makes it possible to remove the lock 8 from the assembly and enables the removal of the screw cover plate 64 and then unscrewing of the screw 63 out to move the attachment member 28 from the cylinder covering the steering shaft, thus the steering wheel can be operated normally. In FIG. 24 and 25, it can be seen that the electrical-electronic circuit including the motor of the present invention do not function, the owner of the automobile can use a key 9 to unlock the lock 8 and then pull out the lock latch 8b out from the hole 8d of the lock 8, hole 28a of the attachment member 28 and hole 72a of the screw cover plate 72 respectively. The lock 8 can then be removed from the assembly and thus making it possible to unscrew the screw that hold the invention from the brake-pedal attachment base to allow the steering wheel to operate normally.

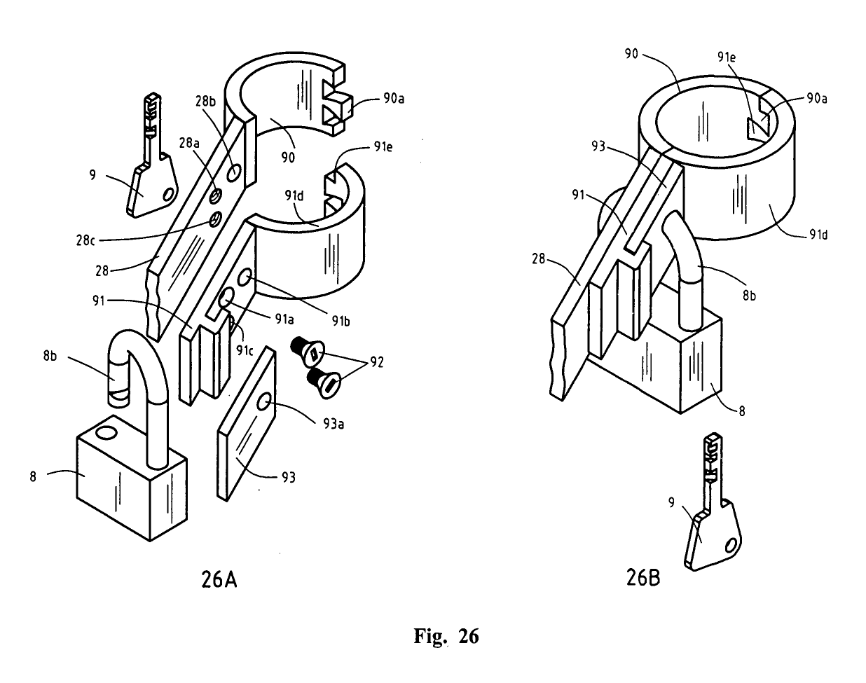

FIG. 26 shows one embodiment of the structure for attaching the invention to the cylinder covering the steering shaft and the way to assemble the lock 8 to such structure. The attaching structure in this figure comprises at least an attachment member 28 having one end connected to the outer cylinder 37 (not shown) and the end side 90 of the attachment member 28 is designed with a curve to fit with the cylinder covering the steering shaft and has a spline 90a for engaging with the spline groove 91e of the attachment leg 91. The attachment leg has an end 91d designed with a curve to fit with the cylinder covering the steering shaft and is also curved to fit with the end 90 of the attachment member 28. Assembly of these components can be achieved by bringing both members to assemble together to install on the cylinder covering the steering shaft as shown in FIG. 26B and then insert the screw 92 through the hole 91a and 91c of the attachment leg 91 and further insert through the thread hole 28a and the thread hole 28c of the attachment member 28 and then tightening this screw (screw 92 can be an ordinary screw for general purpose of dead lock screw without being considered to be departing from the scope of the present invention.) The screw cover plate 93 can then be assembled to the attachment leg 91 by aligning the hole 93a of the screw cover plate to the hole 91b of the attachment leg 91. This screw cover plate then covers the screw head 92 completely to prevent the screw from being unscrewed out. The lock 8 comprising at least a lock shaft 8b can then be assembled together with the members of the structure mentioned above by inserting the lock shaft 8b into the through hole 93a, hole 91b, and hole 28b respectively and then engage the lock. In addition to the lock 8 as shown in the figure which is applied with the invention, the other features of lock can be applied with the invention.

When the motor set or the electrical-electronic circuit including the drive mechanism of the present invention does not function, the owner of the automobile can still use the key 9 to unlock the lock 8 and then pull out the lock latch 8b from the hole 28b, the hole 91b and the hole 93a respectively. This makes it possible to remove the lock 8 from the assembly and enables the removal of the screw cover plate 93 and then unscrewing of the screw 92 out to detach the invention from the cylinder covering the steering shaft.

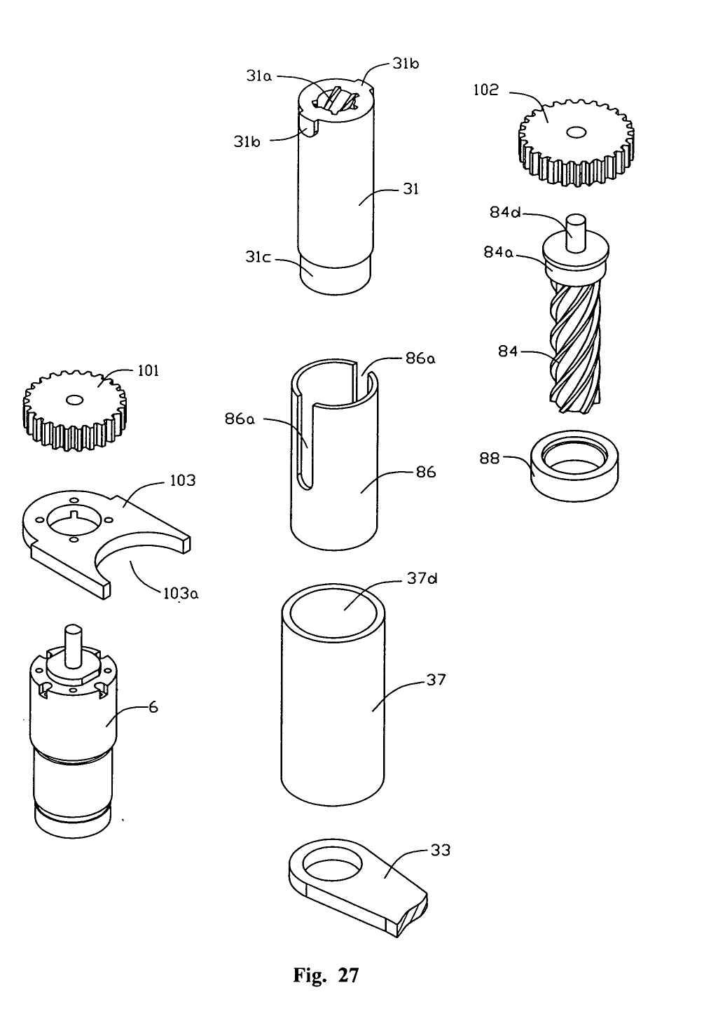

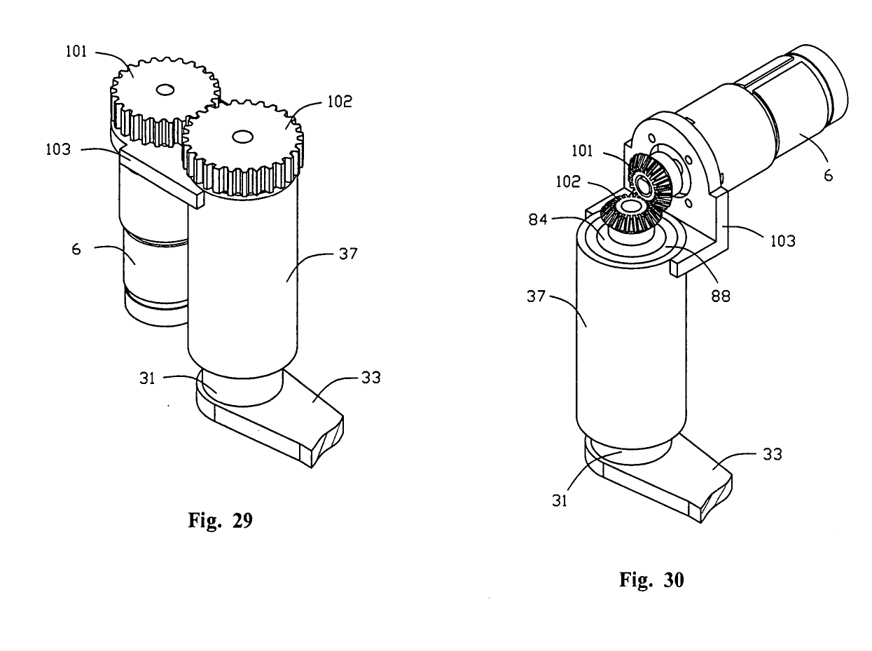

FIG. 27 shows one embodiment of the drive mechanism 7 using drive pinion 101 to fit with the rotation shaft 6a of the motor for rotating and to serve as a driven gear 102 which is fitted on the axis 84d of the spiral gear 84. The motor 6 is attached to the flange 103 connected to the outer cylinder 37. When the parts in FIG. 27 are assembled according to FIG. 29, their operation are as follows: when the motor 6 receives a signal to execute the locking it will rotate so as to force the drive pinion 101 to rotate correspondingly. As a result, the driven gear 102 and the spiral gear 84 rotate correspondingly so that the sliding axis 31 having thread hole 31 a inserted with such spiral gear moves and carries the collet jacket 32 to cover the collet 40 to execute the locking or when the motor 6 receives a signal in order to execute the unlocking it will rotate to force the drive pinion 101 to rotate correspondingly. As a result, the driven gear 102 and the spiral gear 84 rotate correspondingly so that the sliding axis 31 moves and carries the collet jacket 32 away from the collet 40 to execute the unlocking.

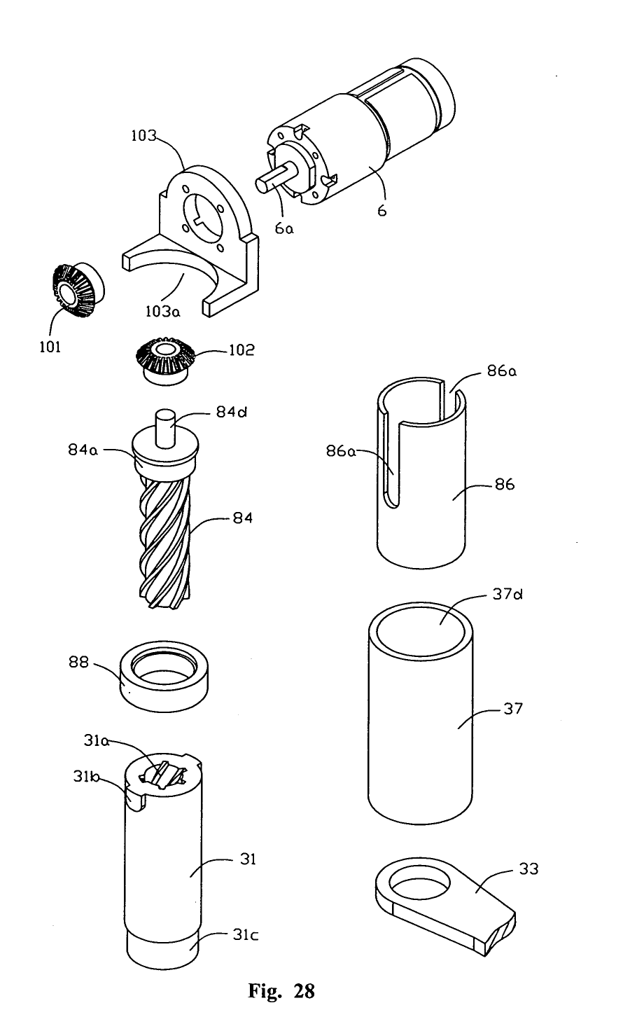

FIG. 28 shows one embodiment of the drive mechanism 7 using drive pinion 101 to fit with the rotation shaft 6a of the motor for rotating and to serve as a driven gear 102 which is fitted on the axis 84d of the spiral gear 84, wherein the drive pinion and the driven gear in FIG. 28 are bevel gears having embodiments different from the that of the drive pinion and the driven gear in FIG. 27. But their main function is to rotate so as to drive the spiral gear 84 to rotate and drive the sliding axis 31 to move and carry the collet jacket 32 to execute the locking or unlocking. Beside the bevel gear and the spur gear, a helical gear, a worm gear, a screw gear, or a rack can also be used for functioning as the drive pinion and driven gear.

From FIG. 27 and FIG. 28, it can be seen that the embodiment of the flange 103 for attaching the motor will change according to the particular type of the drive pinion and driven gear. But the main objective of such the flange 103 is for securely attaching the motor 6 and providing the groove 103a for fitting to the outer cylinder 37 and then tightly connected together. When the parts in FIG. 28 are assembled according to FIG. 30 their operation are as follows: when the motor 6 receives a signal to execute the locking it will rotate to force the drive pinion 101 to rotate correspondingly. As a result, the driven gear 102 and the spiral gear 84 rotate correspondingly so that the sliding axis 31 with thread hole 31a is inserted to make the spiral gear move and carry the collet jacket 32 to cover the collet 40 to execute the locking or when the motor 6 receives a signal to execute the unlocking it will rotate to force the drive pinion 101 to rotate correspondingly. As a result, the driven gear 102 and the spiral gear 84 rotate correspondingly so that the sliding axis 31 moves and carries the collet jacket 32 away from the collet 40 to execute the unlocking.

Apart from being use for preventing the stealing of automobiles, the invention is also applicable to the prevention of the stealing of other types of vehicle having steering axle by improving the drive mechanism including the structure for attachment to suit certain type of vehicle and bring it to work together with the electrical-electronic system of the invention as described above. The improvement of the drive mechanism and the structure for attaching make it possible to apply the invention to prevent the stealing of various types of vehicle.

Any improvement or modification apparent to persons having ordinary skills in the arts is considered to be within the scope and spirit of the present invention as appeared in the Claims attached to the specification.

1. A system and device for locking an automobile steering axis which is a theft prevention device for an automobile, comprising an electrical-electronic system section which comprises at least an encoder device/circuit (1), a main control section (18), a motor (6) used as a power source for drive mechanism (7) to carry the collet jacket (32) to cover a collet (40) to execute the locking or carry the collet jacket (32) away from the collet (40) to execute the unlocking, a control unit (10) for controlling the start system and the mobility system of the automobile including an anti-theft alarm system, an anti-theft alarm system (15), an encoder device/circuit for resetting(11), a decoder circuit for resetting (12) and a mechanical system section that comprises at least a drive mechanism (7), a lock (8), a key (9), a collet jacket (32), and a collet (40);
characterized in that the motor (6) and the main control section (18) including a section having an electric wiring connecting the internal circuit in the main control section to the motor (6) are encased in metal casing to prevent destruction and tempering of the connection of that circuit, wherein the main control section (18) comprises at least a decoder circuit (2), a control circuit (3) for sending an output signal (19) to the control unit (10) for controlling the start system and the mobility system of the automobile including the anti-theft alarm system and sending a control signal (21) to a drive circuit (4) for controlling the operation of motor, and a lock and unlocked state detection section (5) which comprises at least detection device/detection circuit to monitor the number of the rotation cycles or distance that the motor (6) has rotated or to monitor whether a position to which the drive mechanism (7) has moved is the position of lock or unlocked state or not. When the sensor determines whether locking device is in the lock or unlocked state it then sends signal to the control circuit for further operation to control the motor and;
the control unit (10) for controlling the start system and the mobility system of the automobile including an anti-theft alarm system operates to control the operation of the start system controlling unit and the mobility system of the automobile so that they cannot function as usual, wherein such control unit is provided with a channel (17) for connecting to the anti-theft alarm system (15) to set the alarm-ready mode of the anti-theft alarm system. When the locking device is in the locked state and when there is an unusual incident such anti-theft alarm system will activate a siren to emit sound or send radio signal or make a telephone call to the owner of the automobile, persons or organizations concerned to inform the happening of such incident and;
the encoder device/circuit (11) and the decoder circuit for resetting(12) is provided for resetting and canceling the setting of the alarm-ready mode and deactivating the operation of the anti-theft alarm system and returning the start system controlling unit and the mobility system of the automobile back to their normal operating conditions when the encoder device/circuit (1), main control section (18) or the motor (6) cannot be operated and;
the drive mechanism (7) comprises at least a U-shaped metal plate (21) for securely installing the motor (6), wherein such metal plate has a hole (21a) for mounting the rotation shaft (6a) of the motor thereon and such rotation shaft is provided with a worm gear (27) thereon to serve as a drive pinion. The hole (21b) is provided for shaft axis (24) to be fitted thereon, wherein at the shaft axis (24) there are helical gear (25) and spur gear (23) fitted thereon to serve as driven gear to drive a rack (30) with attached to one end of sliding axis (3 1) and the other end of the sliding axis (31) is attached to an arm (33) with one end of such arm connected to the collet jacket (32). Thus, when the sliding axis (31) moves the collet jacket (32) is then carried along to execute the locking or unlocking of the steering axis of automobile. The spur gear (23) has pivots (23a) with at least one protruded pivot to fit into a notch (25a) of the helical gear (25) to help control the two driven gears so that they rotate in the same direction and a lock washer (22) is provided for securely locking the shaft axis (24) so it does not move away from the U-shaped metal plate (21) and there is provided a spring (26) to force the helical gear (25) and the spur gear (23) so they do not move away from each other. At one end of the helical gear (25) a lock (8) is assembled thereon for unlocking in case some parts or entire electrical-electronic system cannot be operated. When the above components and main control section (18) are assembled they are encased in the outer cylinder (37) with a cover (20) to close one end of the outer cylinder (37) to prevent the inside components and devices from destruction and at one end of the outer cylinder is fitted with a bearing member (29) so that the tight connection is achieved, wherein such bearing member is provided with a recess (29a) for supporting the sliding axis (31) so that it can move to execute the locking and unlocking accurately without vibrating, shaking, or being decentered and the attachment members (28) are provided for using in the installation of the locking device permanently to the automobile and;
the collet (40) is provided with a collet member (40a) and collet member (40b), each member being provided with a threaded hole (42) and a hole (49) for inserting screw (46) for attaching the collet member (40) together and making the collet (40) securely attached to the steering axis of the automobile. At the lower surface area of the collet member (40a) or the collet member (40b) is provided with at least one lock hole (41) which the lock latch (36) of the collet jacket (32) is engaged thereon to execute the locking and at the surface area that contact the steering axis of the automobile of the collet member (40a) and collet member (40b) are provided with a streak groove (43) and there is provided a threaded hole (44) for inserting the worm thread screw (45) to securely attach the collet (40) to the steering axis of the automobile and;
the collet jacket (32) is in the form of a covering socket fitting the collet (40) and there are provided notch (51) to avoid the steering axis of the automobile, wherein such collet jacket is provided with at least one lock latch (36) which is inserted into the lock hole (41) of the collet (40), spring (35) for pushing the lock latch (36) into the lock hole (41) so that the locked state is achieved genuinely when the position of the lock hole (41) is aligned with that of the lock latch (36), wherein there is a cover plate (34) preventing the spring (35) and the lock latch (36) from moving away from the collet jacket (32) and functions to determine whether the rotation or distance the motor (6) has arrived or the position the drive mechanism (7) has arrived is a locked or unlocked position and then send a signal to control the operation of motor based on the locked or unlocked position of the locking device detected.

2. A system and device for locking an automobile steering axis according to claim 1 which is applicable to micro-controllers or specially designed integrated circuits for comparing whether a code signal received from encoder device/circuit (1) matches the predetermined code or not. If they match, the micro-controller or specially designed integrated circuit will process and then send output signal (19) to the start system controlling unit and the mobility system of the automobile including the anti-theft alarm system (10) and send the control signal to drive the motor (6) so that it rotates to forces the drive mechanism (7) to carry the collet jacket (32) to cover the collet (40) to execute the locking or carry the collet jacket (32) away from the collet (40) to execute the unlocking.

3. A system and device for locking an automobile steering axis according to claim 1, wherein sending signal to execute the locking or unlocking from the encoder device/circuit (1) to the decoder circuit (2) is a wired signaling or wireless signaling.

4. A system and device for locking an automobile steering axis according to claim 1, wherein sending a resetting signal from the encoder device/circuit for resetting (11) to the decoder circuit for resetting(12) is a wired signaling or wireless signaling.

5. A system and device for locking an automobile steering axis according to claim 1, wherein the control unit (10) for controlling the start system and the mobility system of the automobile including the anti-theft alarm system functions to check whether the signal line connected between the internal circuit in the main control section (18) and the main control section is damaged or short-circuited or not, and if it is damaged or short-circuited, such main control section will send output signal from channel (17) to the anti-theft alarm system (15) to activate the siren to emit sound or send a signal to inform the owner of the automobile, persons or organizations concerned.

6. A system and device for locking an automobile steering axis according to claim 1 permanently installed within an automobile by attaching to the cylinder covering the steering shaft or the vicinity of the cylinder covering the steering shaft, the brake pedal attachment base of the automobile, the body of automobile, or the structure of automobile.

7. A system and device for locking an automobile steering axis according to claim 1, which is used to prevent the stealing of a vehicle having steering axis connected to the steering shaft, wherein when the locking device is in its locked state the steering wheel unable to turn.

8. A system and device for locking an automobile steering axis according to claim 1, wherein the electrical-electronic system including the motor is applicable to control the drive mechanism (7) that has been improved to suit each type and model of automobile or vehicle, wherein such drive mechanism carries the collet jacket (32) to cover the collet (40) to execute the locking or carry the collet jacket (32) away from the collet (40) to execute the unlocking.

9. A system and device for locking an automobile steering axis according to claim 1, wherein the collet (40) are provided with at least one lock groove (41) at the side area of the collet member (40a) or the collet member (40b) so that the lock latch (36) of the collet jacket (32) can be inserted into such lock groove (41) in order to execute the locking, the collet jacket (32) being provided with at least one lock latch (36) for engaging with the lock groove (41) of the collet (40), a spring (35) for pushing the lock latch (36) to engage with the lock groove (41) of the collet (40), a cover plate (34) to prevent the spring (35) and the lock latch (36) from moving apart from the collet jacket (32).

10. A system and device for locking an automobile steering axis according to claim 1, wherein the collet (40) is provided with at least one lock hole (41) at the side area of the collet member (40a) or the collet member (40b) and the collet jacket (32) is provided with at least one lock latch (36) for engaging with the lock hole (41) of the collet (40), wherein the lock latch (36) and the spring (35) is provided in the side surface area of the collet.

11. A system and device for locking an automobile steering axis according to claim 1, wherein the collet (40) is provided with at least one combined set of lock latch (36) and spring (35) to execute the locking, wherein such lock latch is projected outwardly to the lower area of the collet member (40a) or the collet member (40b) and the collet jacket (32) is provided with at least one lock hole (41) so that the spring (35) can push the lock latch (36) into such loch hole to execute the locking.

12. A system and device for locking an automobile steering axis according to claim 1, wherein the collet (40) is provided with at least one combined set of lock latch (36) and spring (35) to execute the locking, such lock latch being projected outwardly to the side of the collet member (40a) or the collet member (40b) and the collet jacket (32) being provided with at least one lock hole (41) so that the spring (35) can push the lock latch (36) into such loch hole to execute the locking.

13. A system and device for locking an automobile steering axis according to claim 1, wherein the drive mechanism (7) comprises at least a metal plate (81) for installing the motor (6), the metal plate being provided with a hole (81a) through which the rotation shaft (6a) of the motor can be inserted, a hole (81b) for inserting the screw (82) into the thread hole (6c) of the motor (6) to securely attach the motor (6) to the metal plate (81); and the metal plate (81) also being provided with a thread hole (81c) for inserting the screw (87) to securely attach the metal plate (81) to the flange (37c) of the outer cylinder (37). Such flange is also provided with a hole (37b) for inserting the screw (87). The rotation axis (6a) of the motor is fitted with a spiral gear (84), such spiral gear being provided with a cone part (84a) to fit with a bush (88) and in the middle of the cone (84a) is provided with a hole to fit the rotation axis (6a) of the motor and the thread hole (84b) for screwing a worm thread screw (85) to force the spiral gear (84) to tightly attach to the rotation axis (6a) of the motor.
The spiral gear (84) is fitted with a bush (88) and then tightened into the thread hole (31a) of the sliding axis (31), such thread hole being provided with teeth conforming to that of spiral gear (84). In addition, the sliding axis (31) is provided with at least one protruded pivot (31b) to fit with the notch (86a) of the metal cylinder (86) which helps preventing the sliding axis (31) from rotating or twisting when moves to execute the locking or unlocking. Such metal cylinder (86) is provided to fit into a recess (37d) of the outer cylinder (37) and then connected together with the end (31c) of the sliding axis connected to the arm (33), while another end of such arm is connected to the collet jacket (32).

14. A system and device for locking an automobile steering axis according to claim 6, wherein the structure for installing the cylinder covering the steering shaft consists of at least attachment members (28) having one end connected to the outer cylinder (37) and the other end connected to the attachment members (61). Such attachment members are curved to fit with the cylinder covering the steering shaft and is provided with a hole (61a) for inserting the screw (63) to install the attachment members (61) to the attachment member (62), wherein the attachment members (62) is also curved to fit with the cylinder covering the steering shaft, and also provided with a thread hole (62a) for inserting the screw (63). In addition, there is provided a screw cover plate (64) to be assembled into the attachment members (28) after the two attachment members are installed to the cylinder covering the steering shaft to close the screw head (63) to prevent such screw from being unscrewed out and the lock (8) with the notch (8e) for attaching the attachment members (28) to the screw cover sheet (64) so that they do not move away from each other.

15. A system and device for locking an automobile steering axis according to claim 6, wherein the structure for installing the device to the brake pedal attachment base of the automobile at least consists of attachment members (28) which is provided for attaching to the brake pedal attachment base of the automobile, with one of it ends connected to the outer cylinder (37) and another end connected the flange (71) with at least one hole (71a) for inserting a male screw of such brake pedal base, a screw cover plate (72) having an end (72c) bent to hook with the end (71b) of the flange (71), a hole (72a) for engaging the lock latch (8b) of the lock (8) to execute the locking, and a thread hole (72b) for inserting the screw (73) to attach the screw cover plate (72) to the attachment members (28) and the lock (8) with the notch (8e) to fit with the attachment members (28) and the screw cover plate (72) to prevent both members from moving away from each other.

16. A system and device for locking an automobile steering axis according to claim 15, wherein the position for assembling the lock (8) into the attachment members (28) and the screw cover plate (72) to prevent both member from moving away from each other can be any area of the attachment member (28) or the screw cover plate (72) and when such assembling is done the screw cover plate (72) tightly covers the screw head (73) to prevent such screw from being unscrewed out.

17. A system and device for locking an automobile steering axis according to claim 9, wherein the collet (40) consists of collet member (40a) and collet member (40b), each member being provided with a thread hole (42) and a hole (49) for inserting the screw (46) to attach the collet member (40) together. The side surface of the collet member (40a) or collet member (40b) is provided with at least one lock groove (41) so that the lock latch (36) of the collet jacket (32) can engage with to execute the locking and the surface that contacts the steering axis of the automobile of the collet member (40a) and the collet member (40b) is designed to have a streak groove (43)and is also provided with a thread hole (44) for tightening the worm thread screw (45). In addition, the upper parts of the collet member (40a) and collet member (40b) are provided with a wing (40d) projected outwardly to close the upper part of the collet jacket (32) while the collet jacket is covering the collet (40) and;
the collet jacket (32) is in the form of a covering socket fitting with the collet (40) and has a notch (51) to avoid the steering axis of the automobile, such collet jacket being connected to the arm (33) of the drive mechanism and is provided with at least one lock latch (36) for engaging with the lock groove (41) of the collet (40), such lock latch (36) having a wing (36a) projected outwardly on both sides, a bush (52) to prevent the lock latch (36) from moving away from the casing part (53), and there is provided a thread hole (52a) for tightening the worm thread screw (54) to attach the casing part (53), a spring (35) to push the lock latch (36) into the lock groove (41) and the casing part (53) for encasing some part of the lock latch (36), the bush (52) and the spring (35) to prevent destruction and detaching of the internal components. Such casing member is provided with a hole for fitting a spring controlling axis (55) thereon so that the spring is not decentered and is provided with a thread hole (53a) for inserting the worm thread screw (54) to securely attach the bush (52) to the casing part (53).

18. A system and device for locking an automobile steering axis according to claim 10, wherein the collet (40) comprises a collet member (40a) and a collet member (40b), each member having a thread hole (42) and a hole (49) for inserting the screw (46) to attach the collet member (40), characterized in that the surface area at the side of such collet is provided with at least one lock hole (41) so that the lock latch (36) of the collet jacket (32) can engage thereon to execute the locking and the surface area that contact to the steering axis of the automobile of the collet member (40a) and the collet member (40b) is provided with a streak groove (43) and is provided with a thread hole (44) for tightening the worm thread screw (45) to help installing the collet (40) securely to the steering axis of the automobile and;
the collet jacket (32) is in the form of a covering socket fitting with the collet (40) and there is provided a notch (51) to avoid the steering axis of the automobile, such collet jacket being provided with at least one of the lock latch (36) which is inserted into the lock hole (41) of the collet (40), such lock latch being provided with a spring (35) for pushing the lock latch (36) into the lock hole (41), such lock latch and spring being positioned inside the hole (57) of the collet jacket (32).

19. A system and device for locking an automobile steering axis according to claim 11, wherein the collet (40) comprises a collet member (40a) and a collet member (40b), each member having a thread hole (42) and a hole (49) for inserting the screw (46) to attach the collet member (40), a hole (40c) for engaging the lock latch (36) and the spring (35). At the upper part of such hole is provided with a female screw for tightening the male screw (56) to close the hole to prevent the lock latch (36) and the spring (35) from moving apart from the collet (40). When the male screw is tightened the head of the screw is destroyed to prevent using of tools to unscrew such male screw out. The surface area that contacts the steering axis of the automobile of the collet member (40a) and the collet member (40b) is provided with a streak groove (43) and with a thread hole (44) for tightening the worm thread screw (45) to help installing the collet (40) securely to the steering axis of the automobile and
the collet jacket (32) is in the form of a covering socket fitting with the collet (40) and there is provided a notch (51) to avoid the steering axis of the automobile and at least one lock hole (41) which the lock latch (36) of the collet jacket (32) is engaged therewith to execute the locking.

20. A system and device for locking an automobile steering axis according to claim 6, wherein the structure for installing the cylinder covering the steering shaft consists of at least attachment members (28) with one end connected to the outer cylinder (37) and the end (90) of the attachment member (28) is curved to fit with cylinder covering the steering shaft and has teeth (90a) to match with the spline (91e) of the attachment leg (91), wherein such leg has an end (91d) curved to fit the cylinder covering the steering shaft and also matching the end (90) of the attachment leg (28). When both members are taken for installing the cylinder covering the steering shaft, a screw (92) is inserted into the hole (91a) and the hole (91c) of the attachment leg (91) and into the tread hole (28a) and the thread hole (28c) of the attachment member (28) and then tightened solidly. The screw cover plate (93) is then assembled to the attachment leg (91) to cover the both screw heads (92) to prevent the screw from being unscrewed out and the lock axis (8b) of the lock is inserted through a hole (93a), a hole (91b) and a hole (28b) respectively to engage the lock.

21. A system and device for locking an automobile steering axis according to claim 1, in which the drive mechanism (7) comprises as least a flange (103) connected to the outer cylinder (37) for attaching the motor (6), such flange (103) being provided with a hole so that the rotation shaft (6a) can be inserted through and a thread hole for inserting a screw to attach the motor to such flange (103), a drive pinion (101) fitted to the rotation shaft (6a) of the motor for rotating and driving the driven gear (102), a spiral gear (84) provided with a axis (84d) protruded outwardly to fit with the driven gear (102), and a cone part (84a) provided for fitting with the bush (88),
The spiral gear (84) being fitted with a bush (88) and then inserted into the thread hole (31a) of the sliding axis (31), such thread hole being in the form of teeth corresponding to the spiral gear (84), the sliding axis (31) being provided with at least one protruding pivot (31b) to fit with the notch (86a) of the metal cylinder (86) to prevent the sliding axis (31) from turning or twisting when it moves to execute the locking or the unlocking, such metal cylinder (86) being provided to fit into the recess (37d) of the outer cylinder (37) and then connected together, and the end (31c) of such sliding axis being connected to the arm (33), one end of such arm being connected to the collet jacket (32)

22. A system and device for locking an automobile steering axis according to claim 21, wherein said drive pinion (101) is a spur gear, a bevel gear, a helical gear, a worm gear, or a screw gear.

23. A system and device for locking an automobile steering axis according to claim 21, wherein said driven gear (102) is a spur gear, a bevel gear, a helical gear, a worm gear, a screw gear, or a rack.
